(19) United States
(12) Patent Application Publication
(10) Pub. No.: US 2025/0162887 A1
(43) Pub. Date: May 22, 2025

(54) Precipitated Silica and Process for Its Manufacture

(71) Applicant: Rhodia Operations, Lyon (FR)

(72) Inventors: Cédric Feral-Martin, Lyon (FR); Emmanuelle Allain Najman, L'Hay les Roses (FR); Pascaline Lauriol-Garbey, St Cyr Au Mont D Or (FR); Thomas Chaussee, Cailloux-sur-Fontaines (FR); Laurent Guy, Lyon (FR)

(21) Appl. No.: 18/723,368

(22) PCT Filed: Dec. 21, 2022
(86) PCT No.: PCT/EP2022/087214

§ 371 Date: Jun. 21, 2024

(30) Foreign Application Priority Data
Dec. 23, 2021 (EP) 21306930.5

(51) Int. Cl. C01B 33/193

(52) U.S. Cl. CPC C01B 33/193; C01P 2004/51; C01P 2004/64; C01P 2006/12

(57) ABSTRACT

The present invention relates to precipitated silica having an improved dispersability and to a process for its manufacture. The invention further relates to the use of precipitated silica as reinforcing filler in polymeric compositions, preferably elastomeric compositions.

### CROSS-REFERENCE TO RELATED APPLICATIONS

This application is the United States national phase of International Patent Application No. PCT/EP2022/087214 filed Dec. 21, 2022, and claims priority to European Patent Application No. 21306930.5 filed Dec. 23, 2021, the disclosures of which are hereby incorporated by reference in their entireties.

### BACKGROUND OF THE INVENTION

### Field of the Invention

The present invention relates to precipitated silica and to a process for its manufacture. The invention further relates to the use of precipitated silica as reinforcing filler in polymeric compositions, preferably elastomeric compositions.

### Description of Related Art

The use of precipitated silica as a reinforcing filler in polymeric compositions is known. In particular it is known to use precipitated silica as reinforcing filler in elastomeric compositions. Such use is highly demanding: the filler has to readily and efficiently incorporate and disperse in the elastomeric composition and, typically in conjunction with a coupling reagent, enter into a chemical bond with the elastomer(s), to lead to a high and homogeneous reinforcement of the elastomeric composition. In general, precipitated silica is used in order to improve the mechanical properties of the elastomeric composition as well as handling and abrasion performance.

WO 03/016215 in the name of the Applicant discloses a precipitated silica having given properties namely in terms of granulometry (measured by XDC or X-ray Disc Centrifuge) and porosity of the primary particles aggregates. Although this silica performs very well as reinforcement for elastomeric compositions, the Applicant has now found that in order to improve the dispersability of such a precipitated silica in polymeric compositions (which in turn improves their wear resistance), it is advantageous to have inhomogeneous aggregates showing a core/shell structure with a friable core.

### SUMMARY OF THE INVENTION

It has been found that a good dispersion in elastomeric compositions can be obtained by the use of a precipitated silica characterised by:
a CTAB surface area in the range from 40 to 525 m²/g;
primary particles having an average size measured by SAXS below 15 nm;
a proportion (by weight) of particles of a size less than 1 μm after deagglomeration by ultrasounds, which is of at least 91%; and
a particle size distribution measured by centrifugal sedimentation using a CPS, such that for a given value of the CTAB surface area, parameter FWHM is defined by relation (I):

$$\vert FWHM \vert > - 0.16 \times \vert CTAB \vert + 130 \qquad ( I )$$

### DESCRIPTION OF THE INVENTION

In the present specification, the terms “silica” and “precipitated silica” are used as synonyms.

In the present specification numerical ranges defined by the expression “between a and b” indicate a numerical range which excludes end values a and b. Numerical ranges defined by the expression “from a to b” indicate a numerical range which includes end values a and b.

Numerical ranges defined by the expression “a is at least b” indicate ranges wherein a is equal to or greater than b.

For the avoidance of doubts, the symbol “×” in relation (I) represents the multiplication sign, such that the expression “a×b” means a multiplied by b. In relation (I), |CTAB| represents the numerical value of the CTAB surface area expressed in m²/g. |CTAB| is an adimensional number. As an example if the measured value of the CTAB is 200 m²/g, |CTAB| is 200.

The same applies to the other values between | | below, which are all the adimensional numerical value of the parameter between said vertical bars.

The CTAB surface area is a measure of the external specific surface area as determined by measuring the quantity of N hexadecyl-N,N,N-trimethylammonium bromide adsorbed on the silica surface at a given pH.

The CTAB surface area is at least 40 m²/g, typically at least 60 m²/g. The CTAB surface area may be greater than 70 m²/g. The CTAB surface area may even be greater than 110 m²/g, greater than 120 m²/g, greater than 130 m²/g, possibly even greater than 150 m²/g.

The CTAB surface area does not exceed 525 m²/g, typically not 300 m²/g. The CTAB surface area may be lower than 280 m²/g, lower than 250 m²/g, lower than 230 m²/g, possibly even lower than 210 m²/g, lower than 190 m²/g, lower than 180 m²/g or lower than 170 m²/g.

Especially for elastomer reinforcement applications advantageous ranges for the CTAB surface area are: from 50 to 300 m²/g, preferably from 70 to 300 m²/g, more preferably from 80 to 270 m²/g or alternatively, from 120 to 275 m2/g. Good results were notably obtained when the CTAB surface area was greater than 70 m²/g and lower than 250 m²/g, in particular when the CTAB surface area was greater than 120 m²/g and lower than 230 m²/g, more particularly when the CTAB surface area was greater than 120 m²/g and lower than 180 m²/g.

The BET surface area of the inventive silica is not particularly limited but it is preferably at least 10 m²/g higher than the CTAB surface area. The BET surface area is generally at least 80 m²/g, at least 100 m²/g, at least 120 m²/g, at least 140 m²/g, at least 160 m²/g, at least 170 m²/g, at least 180 m²/g, and even at least 200 m²/g. The BET surface area may be as high as 300 m²/g, even as high as 350 m²/g; the BET surface may also be of at most 260 m²/g, at most 240 m²/g, at most 220 m²/g, possibly even at most 200 m²/g, at most 180 m²/g or at most 170 m²/g. In many embodiments, the BET surface area ranged from 100 m²/g to 300 m²/g.

The difference between the BET surface area and the CTAB surface area is generally taken as representative of the microporosity of the precipitated silica in that it provides a measure of the pores of the silica which are accessible to nitrogen molecules but not to larger molecules, like N hexadecyl-N,N,N-trimethylammonium bromide.

The precipitated silica of the invention is preferably characterised by a difference between the BET surface area and the CTAB surface area of at least 5 m²/g, preferably at least 10 m²/g. This difference is preferably not more than 40 m²/g, preferably not more than 35 m²/g.

The inventive silica may be essentially free or even completely free of aluminium. The inventive silica may contain aluminium in an amount W_{Al} below 0.50 wt %, preferably below 0.45 wt %, typically of at least 0.01 and lower than 0.50 wt %, preferably of at least 0.01 and lower than 0.45 wt % or alternatively an amount W_{Al} of at least 0.50 wt % and typically of at most 3.00 wt %, generally of at most 5.00 wt % or at most 7.00 wt %. Certain suitable aluminium ranges W_{Al} are from 0.01 up to less than 0.25 wt % (in particular, from 0.05 wt % up to less than 0.25 wt %), and from 0.25 wt % up to less than 0.50 wt % (in particular, from 0.25 wt % up to less than 0.45 wt %). Certain other suitable aluminium ranges W_{Al} are from 0.50 wt % to 1.50 wt % (in particular, from 0.50 wt % to 1.00 wt %), and from more than 1.50 wt % up to 3.00 wt %. For the avoidance of doubt, the term “below” is used herein under its usual, commonly accepted meaning, that is “less than a particular amount or level”, as it can be notably found in Cambridge's Dictionary (online version available at https://dictionary.cambridge.org/dictionary/english/below); likewise, the term “lower” is also used herein under its usual, commonly accepted meaning, that is “positioned below”, as it can be found notably in Cambridge's Dictionary, so the terms “below” and “lower than”, as used herein, have the same meaning, which is their usual, commonly accepted meaning”. Throughout the present text the amount of aluminium, W_{Al}, is defined as the percentage amount by weight of aluminium, meant as aluminium metal, with respect to the weight of SiO₂. The amount of aluminium is preferably measured using XRF wavelength dispersive X-ray fluorescence spectrometry. This aluminium is generally at least in part coming from the raw materials. In some embodiments, an aluminium compound (like sodium aluminate) is added during the synthesis of the precipitated silica and/or during the liquefaction step as described below.

It has to be understood that the inventive silica may contain elements of which non-limiting examples are for instance Al, Ga, B, Sc, Y, Ti, Zr, Hf, V, Nb, Ta, Fe, Co, Mg, Ca or Zn. Hence, in one embodiment, the silica of the invention contains at least one element selected from Al, Ga, B, Sc, Y, Ti, Zr, Hf, V, Nb, Ta, Fe, Co, Mg, Ca or Zn; in particular, the silica of the invention may contain Al and at least one element selected from Ga, B, Sc, Y, Ti, Zr, Hf, V, Nb, Ta, Fe, Co, Mg, Ca and Zn.

The precipitated silica of the invention is further characterised by a broad particle size distribution and by small sized primary particles. The term particle is used to refer to the smallest aggregate of primary silica particles that can be broken by mechanical action. In other words, the term “particles” refers to assemblies/aggregates of indivisible primary particles, said aggregates being characterized by the claimed FWHM while the indivisible primary particles are characterized by their claimed average size. The aggregates preferably have a core/shell structure. Advantageously, the core is composed of larger primary particles than the shell, said core being hence more friable.

The precipitated silica according to the invention has primary particles having a size d_{ZS} measured by SAXS (Small Angle X-ray Scattering, as described below) below 15 nm, preferably below 14 nm, more preferably below 13 nm. Generally, the size of the primary particles is above 4 nm, preferably above 5 nm and more preferably above 6 nm. Certain suitable ranges for d_{ZS} are between 5 and 15 nm, preferably between 6 and 14 nm, possibly from 6 to 13 nm, from 7 to 13 nm, from 6 to 12 nm, from 7 to 12 nm, from 6 to 11 nm, from 7 to 11 nm, from 6 to 10 nm or from 7 to 10 nm. Typically, the primary particles of the silica according to the invention all have a particle size in the same range (generally between 5 and 15 nm, preferably between 6 and 14 nm, more preferably between 5 and 11 nm and still more preferably between 6 and 10 nm), meaning in fact that there is one population of primary particles.

The L_{d} of the precipitated silica according to the invention is typically at least 1.00, preferably at least 1.25, more preferably at least 1.50. This L_{d} is generally below 2.10, typically below 2.00. The L_{d} of the inventive silica is preferably between 1.00 and 2.00, more preferably between 1.50 and 1.90. The L_{d} is defined as follows: L_{d}=(d₈₄−d₁₆)/d₅₀, wherein dn is the particle diameter below which one finds n % of the total measured mass. L_{d} is an adimensional number calculated on the cumulative particle size curve.

Parameter FWHM, determined by means of centrifugal sedimentation in a disc centrifuge using a CPS as detailed hereafter, is used to characterize the width of the particle size distribution of the precipitated silica according to the invention. FWHM (or Full Width at Half Maximum) is obtained from the CPS differential curve. The FWHM measures the distribution width of silica objects around an average size defined by the mode (in nm). If FWHM is large around the average value, the silica product is heterogeneous. If the FWHM is sharp around the average value, the silica product is more homogeneous. In case of a Gaussian particle size distribution (which is barely the case in practice), parameter FWHM is correlated to parameter L_{d}.

The FWHM of the precipitated silica according to the invention is generally of at least 80, very often of at least 90, often of at least 100 and sometimes of at least 110. Besides, parameter FWHM is generally of at most 300, very often of at most 250, often of at most 200, and possibly of at most 190, at most 180, at most 170 or at most 160. Good results were obtained with a FWHM ranging from 100 to 250.

As above specified, the parameter FWHM of the precipitated silica according to the invention complies with relation (I):

$$\vert FWHM \vert > - 0.16 \times \vert CTAB \vert + 130 \qquad ( I )$$

Possibly, the parameter FWHM of the precipitated silica according to the invention complies with relation (I₁):

$$\vert FWHM \vert > {k}_{1} \times - 0.16 \times \vert CTAB \vert + 130 \qquad ( {I}_{1} )$$

wherein k₁ is an adimensional number which is equal to 1.20.

Besides, the parameter FWHM of the precipitated silica according to the invention usually complies with relation (I₂):

$$\vert FWHM \vert < {k}_{2} \times - 0.16 \times \vert CTAB \vert + 130 \qquad ( {I}_{2} )$$

wherein k₂ is an adimensional number which is equal to 3.00.

Often, the parameter FWHM of the precipitated silica according to the invention complies with relation (I₃):

$$\vert FWHM \vert < {k}_{3} \times - 0.16 \times \vert CTAB \vert + 130 \qquad ( {I}_{3} )$$

wherein k₃ is an adimensional number which is equal to 2.20.

Sometimes, the parameter FWHM of the precipitated silica according to the invention complies with relation (I₄):

$$\vert FWHM \vert < {k}_{4} \times - 0.16 \times \vert CTAB \vert + 130 \qquad ( {I}_{4} )$$

wherein k₄ is an adimensional number which is equal to 1.80.

The FWHM of the precipitated silica according to the invention may comply with relations (I) and (I₂). It may also comply with relations (I) and (I₃). It may also comply with relations (I) and (I₄). It may also comply with relations (I₁) and (I₂). It may also comply with relations (I₁) and (I₃). It may also comply with relations and (I₁) and (I₄).

The d₅₀ of the precipitated silica according to the invention is determined by means of centrifugal sedimentation in a disc centrifuge using a CPS as detailed hereafter. d₅₀ actually represents the particle diameter below (and above) which 50% of the total mass of particles is found. Thus, d₅₀ represents the median particle size of a given distribution, wherein the term “size” in this context has to be intended as “diameter”.

The d₅₀ of the inventive silica is preferably characterised by the following formula: |d₅₀|>−0.81×|CTAB|+263. Typically, this d₅₀ is comprised between 110 nm and 240 nm, preferably between 130 and 220 nm.

The d₈₄ of the inventive silica is preferably characterised by the following formula: |d₈₄|<2.81 x|FWHM|+35. Typically, this d₈₄ is comprised between 200 and 550 nm, preferably between 250 and 500 nm.

The rate of fines (τf), that is to say the proportion (by weight) of particles of a size less than 1 μm after deagglomeration by ultrasounds (determined by the “sedigraph” test method described below), is also a way illustrate the ability to disperse of the precipitated silica according to the invention. According to the invention, τf is of at least 91%. In a preferred embodiment, this rate of fines τf is of at least 92%. The rate of fines τf is more preferably of at least 94% and still more preferably of at least 95%; in some especially preferred embodiments, τf may be of at least 96%, at least 97%, of at least 98% or of at least 99%. Often, τf is of at most 99%; sometimes, it is of at most 98%. Certain suitable ranges for the rate of fines τf are from 95% to 99% and from 96% to 99%. It is understood that these values can apply to any precipitated silica, irrespectively of its form. They can notably apply to a product which has not been granulated i.e. to powder or to micropearls. They can also apply to granules.

Precisely, the form of the inventive precipitated silica is not particularly limited. The inventive silica can thus be notably in a form selected from the group consisting of a powder, substantially spherical beads (commonly referred to as “micropearls”), granules and mixtures thereof. In some embodiments, it is the form of a powder. In some other embodiments, it is in the form of micropearls. In still other embodiments, it is in the form of granules.

A second object of the present invention is a process for preparing a precipitated silica, said process comprising:
(i) providing a starting solution having a pH from 2.00 to 5.50,
(ii) simultaneously adding a silicate and an acid to said starting solution to obtain a reaction medium of which the pH is maintained in the range from 2.00 to 5.50,
(iii) stopping the addition of the acid and of the silicate and adding a base to the reaction medium to raise the pH of said reaction medium to a value from 7.00 to 10.00,
(iv) simultaneously adding to the reaction medium a silicate and an acid, such that the pH of the reaction medium is maintained in the range from 7.00 to 10.00,
(v) stopping the addition of the silicate while continuing the addition of the acid to the reaction medium to reach a pH of the reaction medium of less than 6.00 and obtaining a suspension of precipitated silica,
wherein step (i) comprises the following steps:
(ia) providing an aqueous medium eventually comprising an electrolyte as initial stock,
(ib) simultaneously adding to this aqueous medium a silicate and an acid, such that the pH of the aqueous medium is maintained in the range from 7.00 to 10.00, wherein the amount of silicate added to the aqueous medium is between 1 and 10% of the total amount of silicate required for the reaction, preferably between 5 and 9% of the total amount of silicate required for the reaction, (ic) stopping the addition of silicate while continuing the addition of the acid to the aqueous medium obtained in step (ib) in order to provide the starting solution having a pH from 2.00 to 5.50.

Said process is especially well suited for preparing the precipitated silica of the first object. Therefore, said second object of the present invention is advantageously a process for preparing the precipitated silica of the first object, said process comprising:
(i) providing a starting solution having a pH from 2.00 to 5.50,
(ii) simultaneously adding a silicate and an acid to said starting solution to obtain a reaction medium of which the pH is maintained in the range from 2.00 to 5.50,
(iii) stopping the addition of the acid and of the silicate and adding a base to the reaction medium to raise the pH of said reaction medium to a value from 7.00 to 10.00,
(iv) simultaneously adding to the reaction medium a silicate and an acid, such that the pH of the reaction medium is maintained in the range from 7.00 to 10.00,
(v) stopping the addition of the silicate while continuing the addition of the acid to the reaction medium to reach a pH of the reaction medium of less than 6.00 and obtaining a suspension of precipitated silica,
wherein step (i) comprises the following steps:
(ia) providing an aqueous medium eventually comprising an electrolyte as initial stock,
(ib) simultaneously adding to this aqueous medium a silicate and an acid, such that the pH of the aqueous medium is maintained in the range from 7.00 to 10.00, wherein the amount of silicate added to the aqueous medium is between 1 and 10% of the total amount of silicate required for the reaction, preferably between 5 and 9% of the total amount of silicate required for the reaction,
(ic) stopping the addition of silicate while continuing the addition of the acid to the aqueous medium obtained in step (ib) in order to provide the starting solution having a pH from 2.00 to 5.50.

The total amount of silicate to obtain a given final amount of silica can be determined by the person skilled in the art at the beginning of the process according to common general knowledge. The amount of silicate added during step (ib) will be designated below as AS0 silicate ratio.

The term “base” is used herein to refer to one or more than one base which can be added during the course of the inventive process and it includes the group consisting of silicates as defined hereafter. Any base may be used in the process. In addition to silicates, notable non-limiting examples of suitable bases are for instance alkali metal hydroxides and ammonia. Preferably, the base is a silicate and more preferably, the same silicate as the one used in the process.

The term “silicate” is used herein to refer to one or more than one silicate which can be added during the course of the inventive process. The silicate is typically selected from the group consisting of the alkali metal silicates. The silicate is advantageously selected from the group consisting of sodium and potassium silicate. The silicate may be in any known form, such as metasilicate or disilicate. It can be sourced from diverse materials like sand, natural sources containing silica, either combusted (like RHA or Rice Hull Ash) or as such, and even from waste (from construction, mining etc.).

In the case where sodium silicate is used, the latter generally has a SiO₂/Na₂O weight ratio of from 2.0 to 4.0, in particular from 2.4 to 3.9, for example from 3.1 to 3.8.

The silicate may have a concentration (expressed in terms of SiO₂) of from 3.9 wt % to 25.0 wt %, for example from 5.6 wt % to 23.0 wt %, in particular from 5.6 wt % to 21.0 wt %.

The term “acid” is used herein to refer to one or more than one acid which can be added during the course of the inventive process. Any acid may be used in the process. Use is generally made of a mineral acid, such as sulfuric acid, nitric acid, phosphoric acid or hydrochloric acid, or of an organic acid, such as a carboxylic acid, e.g. acetic acid, formic acid or carbonic acid. Good results were obtained with sulphuric acid.

The acid may be metered into the reaction medium in diluted or concentrated form. The same acid at different concentrations may be used in different stages of the process. Preferably, a diluted acid is used until the gel point is reached (which happens during step (ii)) and a concentrated acid is used after the point of gel is reached. Preferably, the dilute acid is dilute sulfuric acid (i.e. with a concentration very much less than 80% by mass, preferably a concentration of less than 20% by mass, in general less than 14% by mass, in particular of not more than 10% by mass, for example between 5% and 10% by mass). Advantageously, the concentrated acid is concentrated sulfuric acid, i.e. sulfuric acid with a concentration of at least 80% by mass (and in general of not more than 98% by mass), preferably of at least 90% by mass; in particular, its concentration is between 90% and 98% by mass, for example between 91% and 97% by mass.

In a preferred embodiment of the process sulfuric acid and sodium silicate are used in all of the stages of the process. Preferably, the same sodium silicate, that is sodium silicate having the same concentration expressed as SiO₂, is used in all of the stages of the process.

In step (i) of the process a starting solution having a pH from 2.00 to 5.00 is provided in the reaction vessel. Preferably, the starting solution has a pH from 2.50 to 5.00, especially from 3.00 to 4.50; for example, the pH is from 3.50 to 4.50.

According to the invention, this starting solution is prepared using namely the following steps (ia) to (ic) as described above.

Without willing to be bound by a theory, the Applicant believes that during these sub-steps of step (i), bigger primary particles are generated than in the subsequent steps of the process (namely during steps (ii) and (iv)) which allows reaching inhomogeneous aggregates with a large particle size distribution.

The starting solution of step (i) may or may not comprise an electrolyte. Preferably, the starting solution of step (i) contains an electrolyte in order to help recycling water streams in the process.

The term “electrolyte” is used herein in its generally accepted meaning, i.e. to identify any ionic or molecular substance which, when in solution, decomposes or dissociates to form ions or charged particles. The term “electrolyte” is used herein to indicate that one or more than one electrolyte may be present. Mention may be made of electrolytes such as the salts of alkali metals and alkaline-earth metals. Advantageously, the electrolyte for use in the starting solution is the salt of the metal of the starting silicate and of the acid used in the process. Notable examples are for example sodium chloride, in the case of the reaction of a sodium silicate with hydrochloric acid or, preferably, sodium sulfate, in the case of the reaction of a sodium silicate with sulfuric acid. Preferably, the electrolyte does not contain aluminium.

Preferably, when sodium sulfate is used as electrolyte in step (i), its concentration in the starting solution is from 5 to 40 g/L, especially from 8 to 30 g/L, for example from 10 to 25 g/L.

Step (ii) of the process comprises a simultaneous addition of an acid and of a silicate to the starting solution. The rates of addition of the acid and of the silicate during step (ii) are controlled in such a way that the pH of the reaction medium is maintained in the range from 2.00 to 5.50. The pH of the reaction medium is preferably maintained in the range from 2.50 to 5.00, especially from 3.00 to 5.00, for example from 3.20 to 4.80.

The simultaneous addition in step (ii) is advantageously performed in such a manner that the pH value of the reaction medium is always equal (to within ±0.20 pH units) to the pH reached at the end of step (i).

Preferably, step (ii) consists of a simultaneous addition of acid and silicate as detailed above. Generally, a point of gel is reached during step (ii). In one embodiment, the amount of silicate added during step (ii) after the point of gel is reached is between 5% and 55% of the total amount of silicate added during step (ii), preferably between 10% and 50% and more preferably 15% and 45% of the total amount of silicate added during step (ii). The point of gel is defined as the point where the reaction medium undergoes an abrupt change in viscosity, which can be determined by measuring the torque on the agitator. Generally, the agitation torque increases by a value between 20% and 60% compared to the torque value before the point of gel, preferably by a value between 25% and 55%, more preferably by a value between 30% and 50% compared to the torque value before the point of gel.

Then, in step (iii), the addition of the acid and of the silicate is stopped and a base is added to the reaction medium. The addition of the base is stopped when the pH of the reaction medium has reached a value of from 7.00 to 10.00, preferably from 7.50 to 9.50.

In a first embodiment of the process the base is a silicate. Thus, in step (iii), the addition of the acid is stopped while the addition of the silicate to the reaction medium is continued until a pH of from 7.00 to 10.00, preferably from 7.50 to 9.50, is reached.

In a second embodiment of the process the base is different from a silicate and it is selected from the group consisting of the alkali metal hydroxides, preferably sodium or potassium hydroxide. When sodium silicate is used in the process a preferred base may be sodium hydroxide.

Thus, in this second embodiment of the process, in step (iii), the addition of the acid and of the silicate is stopped and a base, different from a silicate, is added to the reaction medium until a pH of from 7.00 to 10.00, preferably from 7.50 to 9.50, is reached.

At the end of step (iii), that is to say after stopping the addition of the base, it may be advantageous to perform a maturing step of the reaction medium. This step is preferably carried out at the pH obtained at the end of step (iii). The maturing step may be carried out while stirring the reaction medium. The maturing step is preferably carried out under stirring of the reaction medium over a period of 2 to 45 minutes, in particular from 5 to 25 minutes. Preferably the maturing step does not comprise any addition of acid or silicate.

After step (iii) and the optional maturing step, a simultaneous addition of an acid and of a silicate is performed, such that the pH of the reaction medium is maintained in the range from 7.00 to 10.00, preferably from 7.50 to 9.50.

The simultaneous addition of an acid and of a silicate (step (iv)) is typically performed in such a manner that the pH value of the reaction medium is maintained equal to the pH reached at the end of the preceding step (to within +0.20 pH units), namely step (iii).

Preferably, the amount of silicate added to the reaction medium during step (iv) is at least 45% of the total amount of silicate required for the reaction.

It should be noted that the inventive process may comprise additional steps. For example, between step (iii) and step (iv), and in particular between the optional maturing step following step (iii) and step (iv), an acid can be added to the reaction medium. The pH of the reaction medium after this addition of acid should remain in the range from 7.00 to 9.50, preferably from 7.50 to 9.50.

In step (v), the addition of the silicate is stopped while continuing the addition of the acid to the reaction medium so as to obtain a pH value in the reaction medium of less than 6.00, preferably from 3.00 to 5.50, in particular from 3.00 to 5.00. A suspension of precipitated silica is obtained in the reaction vessel.

At the end of step (v), and thus after stopping the addition of the acid to the reaction medium, a maturing step may advantageously be carried out. This maturing step may be carried out at the same pH obtained at the end of step (v) and under the same time conditions as those described above for the maturing step which may be optionally carried out between step (iii) and (iv) of the process.

The reaction vessel in which the entire reaction of the silicate with the acid is performed is usually equipped with adequate stirring and heating equipment.

The entire reaction of the silicate with the acid (steps (i) to (v)) is generally performed at a temperature from 40 to 97° C., in particular from 60 to 95° C., preferably from 80 to 95° C., more preferably from 85 to 95° C.

According to one variant of the invention, the entire reaction of the silicate with the acid is performed at a constant temperature, usually of from 40 to 97° C., in particular from 80 to 95° C., and even from 85 to 95° C.

According to another variant of the invention, the temperature at the end of the reaction is higher than the temperature at the start of the reaction: thus, the temperature at the start of the reaction (for example during steps (i) to (iii)) is preferably maintained in the range from 40 to 85° C. and the temperature is then increased, preferably up to a value in the range from 80 to 95° C., even from 85 to 95° C., at which value it is maintained (for example during steps (iv) and (v)), up to the end of the reaction.

At the end of the steps that have just been described, a suspension of precipitated silica is obtained, which is subsequently separated (liquid/solid separation). The process typically comprises a further step (vi) of filtering the suspension and drying the precipitated silica.

The separation performed in the preparation process according to the invention usually comprises a filtration, followed by washing, if necessary. The filtration is performed according to any suitable method, for example by means of a belt filter, a rotary filter, for example a vacuum filter, or, preferably a filter press.

The filter cake is then subjected to a liquefaction operation. The term “liquefaction” is intended herein to indicate a process wherein a solid, namely the filter cake, is converted into a fluid-like mass generally by adding a liquid to it. After the liquefaction step the filter cake is in a flowable, fluid-like form and the precipitated silica is in suspension.

The liquefaction step may comprise a mechanical treatment which results in a reduction of the granulometry of the silica in suspension. Said mechanical treatment may be carried out by passing the filter cake through a high shear mixer, a colloidal-type mill or a ball mill. Alternatively, the liquefaction step may be carried out by subjecting the filter cake to a chemical action by addition for instance of an acid or an aluminium compound, for example sodium aluminate. Still alternatively, the liquefaction step may comprise both a mechanical treatment and a chemical action.

The suspension of precipitated silica which is obtained after the optional liquefaction step is subsequently preferably dried, eventually after having been treated by additional chemical(s), like organic one(s) for instance (e.g. polycarboxylic acids).

This drying may be performed according to means known in the art. Preferably, the drying is performed by atomization. To this end, use may be made of any type of suitable atomizer, in particular a turbine, nozzle, liquid pressure or two-fluid spray-dryer. In general, when the filtration is performed using a filter press, a nozzle spray-dryer is used, and when the filtration is performed using a vacuum filter, a turbine spray-dryer is used.

When the drying operation is performed using a nozzle spray-dryer, the precipitated silica that may then be obtained is usually in the form of substantially spherical beads, commonly referred to as “micropearls”. After this drying operation, it is optionally possible to perform a step of milling or micronizing on the recovered product; the precipitated silica that may then be obtained is generally in the form of a powder. After this drying operation, it is also optionally possible to perform a step wherein the recovered micropearls are subjected to an agglomeration step, which consists, for example, of direct compression, wet granulation, extrusion or, preferably, dry compacting; the precipitated silica that is then obtained is generally in the form of granules.

When the drying operation is performed using a turbine spray-dryer, the precipitated silica that may then be obtained may be in the form of a powder.

In one embodiment of the invention, the filter cake is not submitted to a liquefaction step but is directly dried by spin flash drying (for instance by Hosokawa type process).

Finally, the dried, milled or micronized product as indicated previously may optionally be subjected to an agglomeration step, which consists, for example, of direct compression, wet granulation (i.e. with use of a binder, such as water, silica suspension, etc.), extrusion or, preferably, dry compacting.

The precipitated silica that may then be obtained via this agglomeration step is generally in the form of granules.

The inventive precipitated silica can be used in a number of applications, such as catalyst, catalyst support, absorbent for active materials (in particular support for liquids, especially used in food, such as vitamins (vitamin E or choline chloride), as viscosity modifier, texturizing or anticaking agent, or as additive for toothpaste, concrete or paper. The inventive silica may also conveniently be used in the manufacture of thermally insulating materials or in the preparation of resorcinol-formaldehyde/silica composites. The inventive precipitated silica finds a particularly advantageous application as filler in polymeric compositions.

Accordingly, further objects of the invention are (i) a use of the inventive silica as above defined for the manufacture of a filled polymeric composition, and (ii) a composition comprising the inventive silica as above defined and at least one polymer. The phrase “at least one” when referring to the polymer in the composition is used herein to indicate that one or more than one polymer of each type can be present in the composition.

The expression “copolymer” is used herein to refer to polymers comprising recurring units deriving from at least two monomeric units of different nature.

The at least one polymer can be selected among the thermosetting polymers and the thermoplastic polymers, the latter being preferred.

Notable, non-limiting examples of suitable thermoplastic polymers include styrene-based polymers such as polystyrene, (meth)acrylic acid ester/styrene copolymers, acrylonitrile/styrene copolymers, styrene/maleic anhydride copolymers, ABS; acrylic polymers such as polymethylmethacrylate; polycarbonates; polyamides; polyesters, such as polyethylene terephthalate and polybutylene terephthalate; polyphenylene ethers; polysulfones; polyaryletherketones; polyphenylene sulfides; thermoplastic polyurethanes; polyolefins such as polyethylene, polypropylene, polybutene, poly-4-methylpentene, ethylene/propylene copolymers, ethylene/α-olefins copolymers; copolymers of α-olefins and various monomers, such as ethylene/vinyl acetate copolymers, ethylene/(meth)acrylic acid ester copolymers, ethylene/maleic anhydride copolymers, ethylene/acrylic acid copolymers; aliphatic polyesters such as polylactic acid, polycaprolactone, and aliphatic glycol/aliphatic dicarboxylic acid copolymers.

The inventive silica may advantageously be employed as reinforcing filler in elastomeric compositions. Accordingly a preferred object of the invention is a composition comprising the inventive silica and one or more elastomer(s), preferably exhibiting at least one glass transition temperature between −150° C. and +300° C., for example between −150° C. and +20° C.

Notable non-limiting examples of suitable elastomers are diene elastomers. For example, use may be made of elastomers deriving from aliphatic or aromatic monomers, comprising at least one unsaturation such as, in particular, ethylene, propylene, butadiene, isoprene, styrene, acrylonitrile, isobutylene or vinyl acetate, polybutyl acrylate, or their mixtures. Mention may also be made of functionalized elastomers, that is elastomers functionalized by chemical groups positioned along the macromolecular chain and/or at one or more of its ends (for example by functional groups capable of reacting with the surface of the silica), and halogenated polymers. Mention may be made of polyamides, ethylene homo- and copolymer, propylene homo- and copolymer.

Among diene elastomers mention may be made, for example, of polybutadienes (BRs), polyisoprenes (IRs), butadiene copolymers, isoprene copolymers, or their mixtures, and in particular styrene/butadiene copolymers (SBRs, in particular ESBRs (emulsion) or SSBRs (solution)), isoprene/butadiene copolymers (BIRs), isoprene/styrene copolymers (SIRs), isoprene/butadiene/styrene copolymers (SBIRs), ethylene/propylene/diene terpolymers (EPDMs), and also the associated functionalized polymers (exhibiting, for example, pendant polar groups or polar groups at the chain end, which can interact with the silica).

Mention may also be made of natural rubber (NR) and epoxidized natural rubber (ENR).

The polymer compositions can be vulcanized with sulfur or crosslinked, in particular with peroxides or other crosslinking systems (for example diamines or phenolic resins).

In general, the polymer compositions additionally comprise at least one (silica/polymer) coupling agent and/or at least one covering agent; they can also comprise, inter alia, an antioxidant.

Non-limiting examples of suitable coupling agents are for instance “symmetrical” or “unsymmetrical” silane polysulfides; mention may more particularly be made of bis((C1-C4)alkoxyl(C1-C4)alkylsilyl(C1-C4)alkyl) polysulfides (in particular disulfides, trisulfides or tetrasulfides), such as, for example, bis(3-(trimethoxysilyl)propyl) polysulfides or bis(3-(triethoxysilyl)propyl) polysulfides, such as triethoxysilylpropyl tetrasulfide. Mention may also be made of monoethoxydimethylsilylpropyl tetrasulfide. Mention may also be made of silanes comprising masked or free thiol functional groups (like NXT™ or NXT™ Z45 silanes), of mercaptopropyltriethoxysilane, and of a mixture mercaptopropyltriethoxysilane+octyltriethoxysilane (like SI 363© from Evonik).

The coupling agent can be grafted beforehand to the polymer. It can also be employed in the free state (that is to say, not grafted beforehand) or grafted at the surface of the silica. It is the same for the optional covering agent. In case a coupling agent is added to the silica after drying (i.e. grafted on it), it generally is an ethoxy- or a chloro-silane.

The coupling agent can optionally be combined with an appropriate “coupling activator”, that is to say a compound which, mixed with this coupling agent, increases the effectiveness of the latter.

The proportion by weight of the inventive silica in the polymer composition can vary within a fairly wide range. It normally represents from 1% to 250%, in particular from 5% to 200%, especially from 10% to 170%, for example from 20% to 140% or even from 25% to 130%, or alternatively from 10% to 40%, with relation to the amount of the polymer(s). Hence, the % are sometimes referred to as phr or Per Hundred Rubber in case of elastomeric compositions.

The silica according to the invention can advantageously constitute all of the reinforcing inorganic filler and even all of the reinforcing filler of the polymer composition.

The silica of the invention can optionally be combined with at least one other reinforcing filler, for instance with a conventional or a highly dispersible silica, such as Zeosil® Premium SW, Zeosil® Premium 200MP, Zeosil® 1165MP, Zeosil® 1115MP or Zeosil®1085 GR (commercially available from Solvay), or another reinforcing inorganic filler, such as nanoclays, alumina. Alternatively, the silica of the invention may be combined with an organic reinforcing filler, such as carbon black nanotubes, graphene, starch, cellulose and the like.

The silica according to the invention then preferably constitutes at least 30% by weight, preferably at least 60%, indeed even at least 80% by weight, of the total amount of the reinforcing filler.

Still other optional elements of the formulation include accelerators (such as CBS, MBTS, TBzTD and DPG), crosslinking agents (such as peroxide or sulphur), processing oils, resins (terpenes and C5 resins, notably commercialized as Wingtack™ or as Dercolyte™), oligomers of SBR, BR or IR, activators (such as stearic acid and/or zinc oxide), processing aids (such as fatty acids, zinc soaps and PEG), waxes (e.g. PE wax) acting as protectors, antioxidants, UV protectors and antiozonants (such as 6PPD and TMQ)

The inventive silica is characterized by a marked ability to disperse in elastomeric compositions. A known method to determine the ability of a filler to disperse in an elastomeric matrix is described in S. Otto et al. in Kautschuk Gummi Kunststoffe, 58 Jahrgang, NR 7-8/2005. The method, described in more details hereafter, relies on optical analysis and defines the dispersion of the filler in the elastomeric matrix in terms of a Z value which is proportional to the amount of undispersed filler in a matrix, with 100 indicating a perfect mix and 0 a poor mix.

The inventive silica, when dispersed in an elastomeric matrix, is characterised by a Z value which is typically higher than that of comparable mixtures containing prior art silica.

The compositions comprising the precipitated silica of the invention may be used for the manufacture of a number of articles. The compositions comprising the precipitated silica of the present invention may be used in a number of articles. Non-limiting examples of finished articles comprising at least one of the polymer compositions described above, are for instance of footwear soles, floor coverings, gas barriers, flame-retardant materials and also engineering components, such as rollers for cableways, seals for domestic electrical appliances, seals for liquid or gas pipes, braking system seals, pipes (flexible), sheathings (in particular cable sheathings), cables, engine supports, battery separators, conveyor belts, transmission belts or part(s) of tires, e.g. tire treads, the latter being preferred. Yet, many embodiments of the present invention concern a finished article other than any part of a tire, other than any tire and other than any article comprising a tire, said finished article consisting of or comprising at least one part consisting of a composition comprising (i) an inventive precipitated silica and (ii) at least one polymer, possibly one or more elastomer(s); the finished article other than any part of a tire, other than any tire and other than any article comprising a tire may be selected from the group consisting of footwear soles, floor coverings, engineering components (such as rollers for cableways), seals (such as seals for domestic electrical appliances, seals for liquid or gas pipes and braking system seals), pipes (especially flexible pipes), sheathings (in particular cable sheathings), cables, supports (especially engine supports), separators (especially battery separators) and belts (such as conveyor belts and transmission belts).

As above indicated, the inventive precipitated silica may contain aluminium in an amount W_{Al} below 0.50 wt %, preferably below 0.45 wt %, typically of at least 0.01 and lower than 0.50 wt %, preferably of at least 0.01 and lower than 0.45 wt %, and certain suitable aluminium ranges W_{Al} are from 0.01 up to less than 0.25 wt % (in particular, from 0.05 wt % up to less than 0.25 wt %), and from 0.25 wt % up to less than 0.50 wt % (in particular, from 0.25 wt % up to less than 0.45 wt % and from 0.45 wt % up to less than 50 wt %).

An inventive precipitated silica that contains aluminium in an amount W_{Al} below 0.50 wt % can be used in any one of the above described applications. In particular, an inventive precipitated silica that contains aluminium in an amount W_{Al} below 0.50 wt % may advantageously be employed as filler in polymer compositions, especially as reinforcing filler in elastomeric compositions.

Accordingly, a preferred object of the present invention is a composition comprising an inventive precipitated silica that contains aluminium in an amount W_{Al} below 0.50 wt % and at least one polymer, especially a composition comprising an inventive precipitated silica that contains aluminium in an amount W_{Al} below 0.50 wt % and one or more elastomer(s). The nature of the at least one polymer, especially the nature of the elastomer(s), can be as above detailed. The composition may additionally comprise at least one (silica/polymer) coupling agent and/or at least one covering agent; it can also comprise one or more other additive(s), as also above detailed. The proportion by weight of the inventive precipitated silica that contains aluminium in an amount W_{Al} below 0.50 wt % in the polymer composition, especially in the elastomeric composition, can be as above detailed.

An inventive precipitated silica that contains aluminium in an amount W_{Al} below 0.50 wt % may be used for the manufacture of any one of the above specified articles. An inventive precipitated silica that contains aluminium in an amount W_{Al} below 0.50 wt % may be used in any one of the above specified articles. A preferred use of the inventive precipitated silica that contains aluminium in an amount W_{Al} below 0.50 wt % is for the manufacture of one or more part(s) of a tire, e.g. for the manufacture of a tire tread. Another preferred use thereof is in part(s) of a tire, e.g. in tire treads. Accordingly, a preferred object of the present invention is a part of a tire comprising a composition comprising (i) an inventive precipitated silica that contains aluminium in an amount W_{Al} below 0.50 wt % and (ii) at least one polymer, especially a part of a tire comprising a composition comprising (i) an inventive precipitated silica that contains aluminium in an amount W_{Al} below 0.50 wt % and (ii) one or more elastomer(s), and a much preferred object of the present invention is a tire tread comprising a composition comprising (i) an inventive precipitated silica that contains aluminium in an amount W_{Al} below 0.50 wt % and (ii) at least one polymer, especially a tire tread comprising a composition comprising (i) an inventive precipitated silica that contains aluminium in an amount W_{Al} below 0.50 wt % and (ii) one or more elastomer(s). A related object of the present invention is a tire comprising this part, in particular a tire comprising this tread; another related object of the present invention is an article comprising a tire comprising this part, generally a vehicle, especially an automotive vehicle (e.g. a car, a van, a mobile home, a bus, a coach, a truck, or a construction machine such as a backhoe-loader or a dumper), possibly also a non-automotive vehicle (such as a trailer or a cart).

The nature of the at least one polymer, especially the nature of the elastomer(s), can be as above detailed. The composition may additionally comprise at least one (silica/polymer) coupling agent and/or at least one covering agent; it can also comprise one or more other additive(s), as also above detailed. The proportion by weight of the inventive precipitated silica that contains aluminium in an amount W_{Al} below 0.50 wt % in the polymer composition (especially in the elastomeric composition) that is comprised in the tire part (e.g. in the tire tread) can be as above detailed.

As also above indicated, the inventive precipitated silica may alternatively contain aluminium in an amount W_{Al} of at least 0.50 wt % and typically of at most 3.00 wt %, and certain other suitable aluminium ranges W_{Al} are from 0.50 wt % to 1.50 wt % (in particular, from 0.50 wt % to 1.00 wt %), and from more than 1.50 wt % up to 3.00 wt %.

An inventive precipitated silica that contains aluminium in an amount W_{Al} of at least 0.50 wt % may be used as catalyst, catalyst support, absorbent for active materials (in particular, support for oligomers and liquids such as process oils), as viscosity modifier, texturizing or anticaking agent, or as additive for concrete or paper. An inventive precipitated silica that contains aluminium in an amount W_{Al} of at least 0.50 wt % may also be used in the manufacture of thermally insulating materials or in the preparation of resorcinol-formaldehyde/silica composites. An inventive precipitated silica that contains aluminium in an amount W_{Al} of at least 0.50 wt % may also be used as filler in a polymeric composition.

An inventive precipitated silica that contains aluminium in an amount W_{Al} of at least 0.50 wt % may be used for the manufacture of finished articles other than tire parts, other than tires and other than articles comprising tires, and these finished articles may comprise at least one of the polymer compositions described above. An inventive precipitated silica that contains aluminium in an amount W_{Al} of at least 0.50 wt % may be used in finished articles other than tire parts, other than tires and other than articles comprising tires, and these finished articles may comprise at least one of the polymer compositions described above. Accordingly, an object of the present invention is a finished article other than any part of a tire, other than any tire and other than any article comprising a tire, said finished article consisting of or comprising at least one part consisting of a composition comprising (i) an inventive precipitated silica that contains aluminium in an amount W_{Al} of at least 0.50 wt % and (ii) at least one polymer, possibly one or more elastomer(s). The finished article other than any part of a tire, other than any tire and other than any article comprising a tire may be selected from the group consisting of footwear soles, floor coverings, engineering components (such as rollers for cableways), seals (such as seals for domestic electrical appliances, seals for liquid or gas pipes and braking system seals), pipes (especially flexible pipes), sheathings (in particular cable sheathings), cables, supports (especially engine supports), separators (especially battery separators) and belts (such as conveyor belts and transmission belts). The nature of the at least one polymer and, as the case may be, the nature of the elastomer(s), can be as above detailed. The composition may additionally comprise at least one (silica/polymer) coupling agent and/or at least one covering agent; it can also comprise one or more other additive(s), as also above detailed. The proportion by weight of the inventive precipitated silica that contains aluminium in an amount W_{Al} of at least 0.50 wt % in the polymer composition (possibly in the elastomeric composition) that is comprised in the finished article other than any part of a tire, other than any tire and other than any article comprising a tire can be as above detailed.

Should the disclosure of any patents, patent applications, and publications which are incorporated herein by reference conflict with the description of the present application to the extent that it may render a term unclear, the present description shall take precedence.

### Analytical Methods

The physicochemical properties of the precipitated silica of the invention were determined using the methods described hereafter.

### Possible Pretreatment of the Precipitated Silica

When the precipitated silica is in a form of highly agglomerated particles, typically when the precipitated silica is in a form other than a powder, a pretreatment thereof is desirable before applying certain analytical methods, such as a method for determining CTAB surface area and/or a method for determining the primary particles size by SAXS (both methods of concern being detailed here below).

In particular, on the one hand, when the precipitated silica is in the form of micropearls, that is to say a first form of highly agglomerated particles, it is desirable, before applying the method for determining the primary particles size by SAXS, to deagglomerate the micropearls so as to obtain a precipitated silica sample in the form of a powder.

On the other hand, when the precipitated silica is in the form of granules, that is to say another form of highly agglomerated particles, it is desirable, before applying the method for determining the primary particles size by SAXS and also before applying the method for determining CTAB surface area, to deagglomerate the granules so as to obtain a precipitated silica sample in the form of a powder.

In both cases, the same deagglomeration pretreatment was applied, which one is detailed hereinafter.

### Deagglomeration Pretreatment for a Precipitated Silica in a Form of Highly Agglomerated Particles, Especially in the Form of Micropearls or Granules.

Precipitated silicas samples in a form of highly agglomerated particles, especially in the form of granules or micropearls, were smoothly ground using a hand agate mortar and a hand agate pestle, applying manually smooth pressure and friction on the silica samples so as to cause the destruction of the agglomerates and other lumps contained therein. The grinding was operated for a duration sufficient for the samples to acquire a visually homogeneous consistency which was that of a powder; this duration was generally of a few tens of seconds and did not generally exceed 1 min.

For the sake of clarity, the above pretreatment should not be operated when the precipitated silica is in the form of a powder. The above pretreatment could but needs not, and thus shall generally not be operated when applying a method for the determination of BET surface area, a method for the determination of the rate of fines by “sedigraph”, a method for the determination of the amount of aluminium W_{Al} or a method for the determination of water moisture (all such methods being as below detailed) to the precipitated silica, irrespectively of its form. The above pretreatment could also be but needs not, and thus shall generally not be operated when applying a method for determining CTAB surface area to a precipitated silica in the form of micropearls.

### Determination of CTAB Surface Area

CTAB surface area (S_{CTAB}) values were determined according to an internal method derived from standard NF ISO 5794-1, Appendix G. The method was based on the adsorption of CTAB (N hexadecyl-N,N,N-trimethylammonium bromide) on the “external” surface of the silica.

In the method, CTAB was allowed to adsorb on silica under magnetic stirring. Silica and residual CTAB solution were then separated. Excess, unadsorbed CTAB, was determined by back-titration with bis(2-ethylhexyl)sulfosuccinate sodium salt (hereinafter “AOT”) using a titroprocessor, the endpoint being given by the turbidity maximum of the solution and determined using an optrode.

### Equipment

Metrohm Optrode (Wavelength: 520 nm) connected to photometer 662 Metrohm; Metrohm Titrator: Titrino DMS 716; Metrohm titration software: Tiamo.

Glass beaker (2000 mL); volumetric flasks (2000 mL); sealed glass bottles (1000 and 2000 mL); disposable beakers (100 mL); micropipette (500-5000 μL); magnetic stirring bars with 25 mm discs ends (Ref VWR 442-9431) for adsorption; magnetic stirring bars (straight) for titration; polycarbonate centrifugation tubes (at least 20 mL), centrifuge (allowing a 10000 rpm speed); glass vials (30 mL); thermobalance.

### Preparation of the Solutions

Preparation of CTAB solution at 5.5 g/L (buffered at about pH 9.6): in a 2000 mL beaker containing about 1000 mL of distilled water at 25° C. were added: 54.25 g of boric acid solution ([c]=4%); 2.60 g of KCl, 25.8 mL (±0.1 mL) of sodium hydroxide. The so-obtained solution was stirred for 15 min before adding 11.00 g±0.01 g of CTAB powder (99.9% purity, purchased from Merck). After stirring, the solution was transferred to a 2000 mL volumetric flask kept at 25° C. and the volume brought at 2000 mL with distilled water. The solution was transferred in a 2000 mL glass bottle. The solution was kept at a temperature not lower than 22° C. to avoid CTAB crystallization (occurring at 20° C.).

Preparation of AOT solution: about 1200 mL of distilled water in a 2000 mL beaker were heated to 35° C. under magnetic stirring. 3.7038 g of AOT (98% purity, purchased from Aldrich) were added. The solution was transferred to a 2000 mL volumetric flask and allowed to cool back to 25° C. The volume was brought to 2000 mL with distilled water and the solution was transferred in two glass bottles of 1000 mL which were stored at 25° C. in a dark place.

All equipment and solutions were kept at 25° C. during analysis.

Procedure at the beginning and at the end of each experiment

Experiment beginning: solutions were agitated before use. The dosing device was purged before use. At least 40 mL of AOT were passed through the device to ensure that the device is clean and that all the air bubbles were removed. Experiment end: purge the dosing device in order to remove the AOT solution. Clean the optrode. Soak the optrode in distilled water.

### Blank Factor Determination

The variation of AOT and CTAB solutions concentrations, over time, are corrected through the determination of a daily ‘blank factor’ called ratio R1=V1/m1.

In a 100 mL disposable beaker: 4.9000 g±0.0100 g of the 5.5 g/L CTAB solution (m1) were accurately weighed. The tare was set and 23.0000 g±1.0000 g of distilled water (M_{WATER}) were accurately added. The solution was placed under stirring using a magnetic stirrer at 500 rpm on the dosing device and the titration was started. Stirring speed must strictly be steady throughout the titration without generating too much air bubbles.

V1 is the end point volume of AOT solution required to titrate the CTAB solution m1.

The R1 determination is performed at least in duplicate. If the standard deviation of R1=V1/m1 exceeds 0.010, the titration is repeated until the standard deviation is lower or equal to 0.010. The daily ratio R1 is calculated as the average of the 2 or 3 measurements. Note: the optrode must be washed with distilled water after every measurement and dried with absorbent paper.

### CTAB Adsorption on Silica

The moisture content (% H₂O) for each silica sample was determined with a thermobalance (temperature:160° C.) before the adsorption step as follows: tare the balance with an aluminium cup; weigh about 2 g of silica and distribute equally the powder on the cup, close the balance; note the percentage of moisture.

In a 100 mL disposable beaker: 0.0100 g of silica (m0) were accurately weighed. 50.0000 mL+1.0000 mL of the CTAB stock solution (V0) were added. The total mass was recorded. The suspension was stirred for 40 minutes±1 minute on the stirring plate at 450 rpm using magnetic stirring bars with disc ends. After 40 minutes the sample was removed from the stirring plate.

25 to 50 mL of the suspension were transferred in a centrifuge tube (volume depends on centrifuge tube size) and they were centrifuged for 35 minutes at a 10000 rpm speed at 25° C. After centrifugation, the tube was gently removed from the centrifuge not to unsettle the silica. 10 to 20 mL of CTAB solution were transferred in a glass vial which was then stoppered and kept at 25° C.

### Titration of the CTAB Solution

In a 100 mL disposable beaker=4.0000 g±0.0100 g of the CTAB solution at unknown concentration (m2) were accurately weighed.

Tare was set and 19.4000 g±1.0000 g of distilled water (M_{water}) were added. The solution was placed under stirring at 500 rpm on the dosing device and the titration with the AOT solution was started.

V2 is the end point volume of AOT required to titrate an amount m2 of CTAB

### Solution

The CTAB surface area S_{CTAB} is calculated as follows:

$${S}_{CTAB} = \frac{{R}_{1} - {R}_{2}}{{R}_{1}} \times [ CTAB ] i \times 578.435 \times \frac{{V}_{0}}{{M}_{ES}}$$

wherein: S_{CTAB}=surface area of silica (including the moisture content correction) [m²/g]
R1=V1/m1;
m1=mass of the CTAB stock solution titrated as the blank (kg);
V1=end point volume of AOT required to titrate m1 of the CTAB stock solution as the blank (L)
R2=V2/m2;
m2=mass of the CTAB solution titrated after adsorption and centrifugation (kg);
V2=end point volume of AOT required to titrate m2 of the CTAB stock solution after adsorption and centrifugation (L)
[CTAB]i=Concentration of the CTAB stock solution (g/L)
V0=Volume of the CTAB stock solution used for the adsorption on silica (L)
M_{ES}=Solid content of silica used for the adsorption (g) corrected for the moisture content as follows:

$${M}_{E S} = m 0 \times ( 100 - \% {H}_{2} O ) / 100$$

wherein m0=initial mass of silica (g).

### Determination of BET Surface Area

BET surface area SBET was determined according to the Brunauer—Emmett—Teller method as detailed in standard NF ISO 5794-1, Appendix E (June 2010) with the following adjustments: the sample was pre-dried at 160° C.±10° C.; the partial pressure used for the measurement P/P⁰ was between 0.05 and 0.2.

### Determination of the Particle Size Distribution and Particle Size by Centrifugal Sedimentation in a Disc Centrifuge Using a Centrifugal Photosedimentometer (CPS)

Values of d₅₀, d₁₆, d₈₄, FWHM and L_{d} were determined centrifugal sedimentation in a disc centrifuge using a centrifugal photosedimentometer type “CPS DC 24000UHR”, marketed by CPS Instruments company. This instrument is equipped with operating software supplied with the device (operating software version 11g).

Instruments used: for the measurement requirement, the following materials and products were used: Utrasound system: 1500W generator type Sonics Vibracell VC1500/VCX1500 equipped with 19 mm probe (Converters: CV154+Boosters (Part No: BHNVC21)+19 mm Probe (Part No: 630-0208)).

Analytical balance with a precision of 0.1 mg (e.g. Mettler AE260); Syringes: 1.0 ml and 2.0 ml with 20 ga needles; high shape glass beaker of 50 mL (SCHOTT DURAN: 38 mm diameter, 78 mm high); magnetic stirrer with a stir bar of 2 cm; vessel for ice bath during sonication.

Chemicals: deionized water; ethanol 96%; sucrose 99%; dodecane, all from Merck; PVC reference standard from CPS Instrument Inc.; the peak maximum of the reference standard used should be between 200 and 600 nm (e.g. 237 nm).

### Preparation of the Disc Centrifuge

For the measurements, the following parameters were established. For the calibration standard parameters, the information of the PVC reference communicated by the supplier were used.

Sample Parameters

| | | |
|---|---|---|
| max. diameter | μm | 0.79 |
| min. diameter | μm | 0.02 |
| particle density | g/mL | 2.11 |
| particle refrative index | | 1.46 |
| particle absorption | K | 0.001 |
| non-sphericity factor | | 1 |

Calibration Standard Parameters

| | | |
|---|---|---|
| peak diameter | nm | 237 |
| half height peak width | μm | 0.023 |
| particle density | | 1.385 |

Fluid Parameters

| | | |
|---|---|---|
| fluid density | g/mL | 1.051 |
| fluid Refractive Index | | 1.3612 |
| fluid viscosity | cps^{x} | 1.28 |

^{x}cps = centipoise

### System Configuration

The measurement wavelength was set to 405 nm. The following runtime options parameters were established:

| Force Baseline: | Yes |
|---|---|
| Correct for Non-Stokes: | No |
| Extra Software Noise Filtration: | No |
| Baseline Drift Display: | Show |
| Calibration method: | External |
| Samples per calibration: | 1 |

All the others options of the software are left as set by the manufacturer of the instrument.

### Preparation of the Disc Centrifuge

The centrifugal disc is rotated at 24000 rpm during 30 min. The density gradient of sucrose (CAS n°57-50-1) is prepared as follows:

In a 50 mL beaker, a 24% in weight aqueous solution of sucrose is prepared. In a 50 mL beaker, a 8% in weight aqueous solution of sucrose is prepared. Once these two solutions are homogenized separately, samples are taken from each solution using a 2 mL syringe which is injected into the rotating disc in the following order:
Sample 1: 1.8 mL of the 24 wt % solution
Sample 2: 1.6 mL of the 24 wt % solution+0.2 mL of the 8 wt % solution
Sample 3: 1.4 mL of the 24 wt % solution+0.4 mL of the 8 wt % solution
Sample 4: 1.2 mL of the 24 wt % solution+0.6 mL of the 8 wt % solution
Sample 5: 1.0 mL of the 24 wt % solution+0.8 mL of the 8 wt % solution
Sample 6: 0.8 mL of the 24 wt % solution+1.0 mL of the 8 wt % solution
Sample 7: 0.6 mL of the 24 wt % solution+1.2 mL of the 8 wt % solution
Sample 8: 0.4 mL of the 24 wt % solution+1.4 mL of the 8 wt % solution
Sample 9: 0.2 mL of the 24 wt % solution+1.6 mL of the 8 wt % solution
Sample 10: 1.8 mL of the 8 wt % solution

Before each injection into the disk, the two solutions are homogenized in the syringe by aspiring about 0.2 mL of air followed by brief manual agitation for a few seconds, making sure not to lose any liquid.

These injections, the total volume of which is 18 mL, aim to create a density gradient useful for eliminating certain instabilities which may appear during the injection of the sample to be measured. To protect the density gradient from evaporation, we add 1 mL of dodecane in the rotating disc using a 2 mL syringe. The disc is then left in rotation at 24000 rpm for 60 min before any first measurement.

### Sample Preparation

3.2 g of silica in a 50 mL high shape glass beaker (SCHOTT DURAN: diameter 38 mm, height 78 mm) were weighed and 40 mL of deionized water were added to obtain a 8 wt % suspension of silica. The suspension was stirred with a magnetic stirrer (minimum 20 s) before placing the beaker into a crystallizing dish filled with ice and cold water. The magnetic stirrer was removed and the crystallizing dish was placed under the ultrasonic probe placed at 1 cm from the bottom of the beaker. The ultrasonic probe was set to 56% of its maximum amplitude and was activated for 8 min. At the end of the sonication the beaker was placed again on the magnetic stirrer with a 2 cm magnetic stir bar stirring at minimum 500 rpm until after the sampling.

The ultrasonic probe should be in proper working conditions. The following checks have to be carried out and incase of negative results a new probe should be used: visual check of the physical integrity of the end of the probe (depth of roughness less than 2 mm measured with a fine caliper); the measured d₅₀ of commercial silica Zeosil® 1165MP should be 93 nm±3 nm.

### Analysis

Before each samples was analysed, a calibration standard was recorded. In each case 0.1 mL of the PVC standard provided by CPS Instruments and whose characteristics were previously entered into the software was injected. It is important to start the measurement in the software simultaneously with this first injection of the PVC standard. The confirmation of the device has to be received before injecting 100 μL of the previously sonicated sample by making sure that the measurement is started simultaneously at the injection.

These injections were done with 2 clean syringes of 1 mL.

At the end of the measurement, which is reached at the end of the time necessary to sediment all the particles of smaller diameter (configured in the software at 0.02 μm), the ratio for each diameter class was obtained. The curve obtained is called aggregate size distribution.

### Results

The values d₅₀, d₁₆, d₈₄ and L_{d} are on the basis of distributions drawn in a linear scale. The integration of the particle size distribution function of the diameter allows obtaining a “cumulative” distribution, that is to say the total mass of particles between the minimum diameter and the diameter of interest.
d₅₀: is the diameter below and above which 50% of the population by mass is found. The d₅₀ is called median size, that is diameter, of the silica particle.
d₈₄: is the diameter below which 84% of the total mass of particles is measured.
d₁₆: is the diameter below which 16% of the total mass of particles is measured.
L_{d}: is calculated according to equation: L_{d}=(d₈₄−d₁₆)/d₅₀
FWHM: is calculated on the derivative curve of the above mentioned cumulative distribution as explained above in the specification.

### Determination of the Rate of Fines by the “Sedigraph” Method

In this test, the ability to disperse silica is measured by a particle size measurement (by sedimentation) carried out on a silica suspension previously deagglomerated by ultrasonification. Deagglomeration (or dispersion) under ultrasound is implemented using a VIBRACELL BIOBLOCK sonifier (1500 W), equipped with a probe with a diameter of 19 mm. The particle size measurement is carried out using a SEDIGRAPH particle size meter (sedimentation in the gravity field+X-ray beam scanning).

6.4 grams of silica are weighed in a high form beaker (volume equal to 100 ml) and supplemented to 80 grams by adding permuted water: an aqueous suspension of 8% silica is thus made which is homogenized for 2 minutes by magnetic stirring. Deagglomeration (dispersion) under ultrasound is then carried out as follows: the probe being immersed over a length of 3 cm, the output power is adjusted to deliver 58 kJ to the suspension) in 480 seconds. The particle size measurement is then carried out by means of a SEDIGRAPH particle size meter. The measurement is done between 85 μm and 0.3 μm with a density of 2.1 g/mL. The deagglomerated silica suspension, optionally cooled beforehand, is then circulated in the sedigraph particle size cell. The analysis stops automatically as soon as the size of 0.3 μm is reached (about 45 minutes). The fine ratio (τf) is then calculated, i.e. the proportion (by weight) of particles smaller than 1 μm in size. The higher this rate of fines (τf) or particles with a size less than 1 μm is, the better the dispersibility of silica is.

It is understood that the ultrasonic probe should be in proper working conditions. To this end, the following checks can be carried out: (i) visual check of the physical integrity of the end of the probe (depth of roughness less than 2 mm measured with a fine caliper); and/or (ii) the measured of τf commercial silica Zeosil®1165MP, aged for at least 2 years, should be 97%. In case of negative results, the power output should be re-adjusted. If negative results are persisting, a new probe should be used.

### Determination of the Primary Particles Size by SAXS

### 1) Principle of the Method

Small angle X-ray scattering (SAXS) consists of exploiting the deviation of an incident X-ray beam, of wavelength A, passing through the sample, in a cone of a few degrees of angle. A scattering angle θ corresponds to a wave vector defined by the following relation:

$$q = \frac{4 π}{λ} sin \frac{θ}{2}$$

whose unit is Å⁻¹.

Each scattering angle corresponds to a wave vector q defined in the reciprocal space. This wave vector corresponds to a spatial scale defined in the real space, and which is equivalent to 2π/q. Scattering at small angles therefore characterizes large distances in the sample, and conversely scattering at large angles characterizes small distances in the sample. The technique is sensitive to the way matter is distributed in space.

Basic references on this technique are given below:
[1] Small Angle Scattering of X rays, Guinier A., Fournet G., (1955), Wiley, New 5 York.
[2] Small Angle X Ray Scattering, Glatter O., Krattky O., (1982), Academic Press, New York.
[3] Analysis of the Small-Angle Intensity Scattered by a Porous and Granular Medium, Spalla O., Lyonnard S., Testard F., J. Appl. Cryst. (2003), 36, 338-347. 10

The requirements for SAXS to characterize silica according to the following criterion are as follows:

SAXS assembly working in a transmission geometry (i.e. the incident beam passing through the sample), with an incident wavelength between 0.5 and 2 Angströms (Å),
wave vector interval q between 0.015 Å⁻¹ and 0.30 Å⁻¹, which makes it possible to characterize distances in the real space ranging from 420 to 20 Å,
assembly verified in q scale using a suitable standard (e.g. silver behenate, octadecanol or any other compound giving a fine SAXS line included in the interval of q above),
one-dimensional linear detector or preferably two-dimensional,
the assembly must make it possible to measure the transmission of the preparation, i.e. the ratio between the intensity transmitted by the sample and the incident intensity.

Such an assembly may be for example a laboratory assembly, operating on a source of type X-ray tube or rotating anode, preferably using Kα emission of copper at 1.54 Å. The detector can be a CCD detector, an image plate or a gas detector. It can also be a SAXS mount on synchrotron. In the frame of the present application, a CCD detector was used.

### 2) Procedure

The silica sample is analyzed in powdery solid form. The powder is placed between two transparent windows with X-rays. Independently of this preparation, an empty cell is made with only two transparent windows, without silica inside. Diffusion by the empty cell shall be recorded separately from silica diffusion. During this operation, called “background measurement”, the scattered intensity comes from all external contributions to silica, such as electronic background noise, diffusion through transparent windows, residual divergence of the incident beam.

These transparent windows must provide a low background noise in front of the intensity scattered by the silica over the wave vector interval explored. They may consist of mica, Kapton or mylar film, or preferably adhesive Kapton film or mylar with a thin grease layer.

Prior to the actual SAXS acquisition of silica, the quality of the preparation must be checked by means of the transmission measurement of the silica-laden cell.

The steps to be taken are therefore as follows:

2.1) Elaboration of a cell consisting of two silica-free windows (empty cell).

2.2) Elaboration of a cell consisting of two windows, with a sample of silica powder inside.

The amount of silica introduced should be less than 50 mg. The silica must form a layer of thickness less than 100 μm. Preference is given to obtain a monolayer of silica grains arranged on a window, which is easier to obtain with adhesive windows. The quality of the preparation is controlled by the measurement of transmission (step 2.3)).

2.3) Measurement of the transmission of the empty cell and the silica cell.

The R ratio is defined as follows:
R=transmission of silica cell/transmission of empty cell
R should be between 0.85 and 1, in order to minimize the risk of multiple scattering, while maintaining a signal-to-noise ratio satisfactory to large q. If the R-value is too low, the amount of silica visible to the beam should be reduced; if it is too high, silica must be added.

2.4) SAXS acquisition on the empty cell and on the silica cell.

The acquisition times shall be determined in such a way that the signal-to-noise ratio at large q is acceptable. They shall be such that in the immediate vicinity of q=0, 12 Å⁻¹, the fluctuations of the function F(q) defined below shall not exceed +/−5% with respect to the value taken by the function F at that point.

2.5) If a two-dimensional detector has been used: radial grouping of each of the two two-dimensional profiles to obtain the scattered intensity as a function of the wave vector q. The determination of the scattered intensity must take into account the exposure time, the intensity of the incident beam, the transmission of the sample, the solid angle intercepted by the detector pixel. The determination of the wave vector shall take into account the wavelength of the incident beam and the sample-detector distance.

2.6) If a single-dimensional detector has been used: the previous determinations concerning the scattered intensity and the wave vector are to be made, but there is no radial grouping to be expected.

2.7) This leads to two profiles reducing the information to the variation of the scattered intensity as a function of the wave vector q: one profile for the empty cell and one profile for the silica cell.

2.8) Subtraction of the intensity diffused by the empty cell from the intensity scattered by the silica cell (subtraction of “background”).

2.9) The SAXS profile of silica, after subtraction of “background”, has a monotonous decay which is done according to a regime close to the Porod regime, that is to say that the intensity decreases very quickly with the wave vector according to a law close to a power law in q⁻⁴. Small deviations from this Porod law are best visible by representing the data according to the so-called Krattky-Porod method. It is a question of representing F(q) as a function of q, with:

$$F ( q ) = I \times {q}^{4}$$

wherein F represents a SAXS profile in accordance with Kratty-Porod method, I represents the scattered intensity after subtraction of the “background” and q represents the wave vector (in Å⁻¹).

2.10) In the Krattky-Porod representation, when describing the profile, one can possibly observe a maximum, which is related to the existence of primary particles of a roughly defined size. The maximum is all the more marked as the polydispersity is low. In the case of monodispersed primary particles, a second or even a third oscillation to the right of the maximum is observed. The position of the maximum is related to the average size of primary particle by a law in 2Π/q.

Two different determinations can be carried out, both providing information on the dimensions of the primary particles.

A first determination is based on the position of the maximum in I×q⁴=F(q). It corresponds to a spatial scale, given by 2Π/qₘₐₓ. In the case of a single-strip population of spheres, this distance does not correspond exactly to the diameter but to 115% of the diameter diameter (in Å). This exploitation does not give access to a size distribution, but only to an average diameter in which the largest particles have a strong influence.

Another determination provides the average size d_{ZS} (Zimm Schultz average diameter) in accordance with the present invention. Accordingly, a SAXS profile in I×q⁴=F(q) is modelled by a distribution of independent spheres (having different diameters), of type Zimm-Schultz distribution.

The skilled person is well familiar with the use of such a distribution to fit lots of distributions observed in various fields of Chemistry. As reference articles, it can be notably cited:
J. Welch, V. A. Bloomfield, J. Pol. Sci., Polymer Physics Edition, vol. 11 (1973), entitled “Fitting Polymer Distribution Data to a Schulz-Zimm Function”
H. J. Angerman, G. ten Brinke, J. J. M. Slot, The European Physical Journal B, 12, 397-404 (1999), entitled “Influence of polydispersity on the phase behaviour of statistical multiblock copolymers with Schultz-Zimm block molecular weight distributions”, and
L. H. Hanus, H. J. Ploehn, Langmuir, 15, 3091-3100 (1999), entitled “Conversion of Intensity-averaged Photon Correlation Spectroscopy Measurements to Number-Averaged Particle Size Distributions. 1. Theoretical Development”.

This last paper relates to the determination of an average particle diameter of a distribution of particles, as it is the case for the inventive silica. Zimm-Schultz distribution function, as shown in Table 1 of this last paper, was evaluated, and general expressions for converting the intensity-average particle diameter and the polydispersity index to the mean and standard deviation of Zimm-Schultz distribution function can be found in Table 2 of this last paper.

The modelled SAXS profile is based on the well-known SAXS shape factor. Accordingly, for one sphere having a diameter d (d=2×r, wherein r is the sphere radius, in A), we have:

$$I ( q , r ) = \frac{k \times {V}^{2} \times {[ sin ( q \times r ) - q \times r \times cos ( q \times r ) ]}^{2}}{{q}^{6} \times {r}^{6}} \qquad [ equation ( SF ) ]$$

wherein I(q,r) is the scattered intensity of the sphere of diameter d at wave vector q (in Å⁻¹), k is a multiplicative constant, V is the sphere volume [i.e. V=4/3×π×r³] and sin and cos denote respectively sinus and cosinus functions.

For a distribution of independent spheres having different diameters, the (total) scattered intensity I(q) after subtraction of the “background” at wave vector q is

$$I ( q ) = {\int }_{0}^{∞} f ( r ) \times I ( q , r ) dr$$

wherein f(r) is the distribution function of the independent spheres, and I(q,r), r and q are as previously defined; the corresponding SAXS profile F(q) is:

$$F ( q ) = {q}^{4} \times I ( q ) = {q}^{4} \times {\int }_{0}^{∞} f ( r ) \times I ( q , r ) dr$$

Zimm Shultz distribution function of independent spheres f(r)=f_{ZS}(r) is commonly represented by:

$${f}_{ZS} ( r ) = \frac{{a}^{t + 1} \times {r}^{t} \times exp ( - a \times r )}{Γ ( t + 1 )}$$

wherein exp denotes exponential function, F denotes gamma function, r is the sphere radius, and t and a are two parameters which are linked to the average diameter d_{ZS} (in Å) and to the dimensionless polydispersity index iₚ by the following equations:

$$t = \frac{1}{{i}_{p}^{2}} - 1$$

$$a = \frac{2 \times ( t + 1 )}{{d}_{ZS}}$$

The modelled SAXS profile based on independent spheres having a Zimm-Schultz distribution in accordance with the invention F_{ZS}(q) is thus:

$${F}_{ZS} ( q ) = k \times {q}^{4} \times {\int }_{0}^{∞} \frac{\begin{matrix}{a}^{t + 1} \times {r}^{t} \times exp ( - a \times r ) \times {V}^{2} \times \\ {[ sin ( q \times r ) - q \times r \times cos ( q \times r ) ]}^{2}\end{matrix}}{Γ ( t + 1 ) \times {q}^{6} \times {r}^{6}} dr$$

wherein q (in Å⁻¹), r (in Å), V (in Å³), k, a and t are as previously defined, and wherein exp, Γ, sin and cos denote the same functions as above specified.

Thus, the modelled profile needs two inputs to be fitted: 1) average diameter d_{ZS} and 2) polydispersity index iₚ (through parameters t and a).

In addition, multiplicative constant k is used to adjust F_{ZS} profile in the y axis.

These inputs can be determined using conventional numerical tools or on a trial and error basis, in order to best match F(q)=I·q⁴ (SAXS profile in Krattky-Porod's representation) inside a wave vector interval [qₘᵢₙ, qₘₐₓ] which must include the wave vector point at which F(q) reaches its maximum (for the avoidance of doubt, qₘᵢₙ and qₘₐₓ, expressed in Å⁻¹, denote respectively the lower and upper bounds of the wave vector interval). The best fit will be found when the modelled data and the experimental data match as closely as possible in the interval surrounding the maximum (that is to say when the sum of the differences between the squares of the experimental values for F(q) and the modelled values F_{ZS}(q) is minimum).

In practice, Zimm-Schultz distribution is discretized into classes inside a selected radius interval [rₘᵢₙ, rₘₐₓ]. At a given wave vector, each class of discretized Zimm Schultz distribution contributes to the modelled SAXS profile F_{ZS}(q) through its shape factor [I(q,r), equation (SF)] and its weight f_{ZS}(r):

$${F}_{ZS} ( q ) = {q}^{4} \times {I}_{ZS} ( q )$$

$${I}_{ZS} ( q ) = {\sum }_{{r}_{min}}^{{r}_{max}} {f}_{ZS} ( r ) \times I ( q , r ) dr$$

wherein F_{ZS}(q) is the modelled SAXS profile, I_{ZS}(q) is the modelled scattered intensity, f_{ZS}(r) is Zimm Schultz distribution function, I(q,r) is the scattered intensity of a sphere, q is the wave vector, r is the sphere radius and rₘᵢₙ and rₘₐₓ are the lower and upper bounds of the selected interval for the sphere radius. The selected interval shall include Zimm Schultz average radius r_{ZS} (r_{ZS}=d_{ZS}/2). Typically, a skilled person may select for rₘᵢₙ a value close to expected r_{ZS}/20 (r°_{ZS}/20, with r°_{ZS} as defined below) and define 50 values which follow a geometric progression with a ratio of 1.1. Other choices are possible as long as the diameter distribution is correctly taken into account in the modelled profile. The choice of initial values for the determination of r_{ZS} and iₚ (respectively, r°_{ZS} and i°ₚ) as starting point for an iterative determination process is not especially critical. A skilled person may e.g. advantageously use r°_{ZS}=40 Å and iₚ=0.50 as starting values; these ones are especially suitable for the silicas in accordance with the present invention. Alternatively or complementarily, the skilled person may rely on TEM measurements.

For convenience, the calculations may be made after introducing the above formulae in a spreadsheet.

This model does not take into account aggregation, therefore the existence of correlations between spheres; it also does not take into account consolidation, i.e. the presence of additional material that welds the primary particles.

2.11) From Zimm-Schultz distribution model, we determine the SAXS particle size which is an average diameter d_{ZS} (Zimm-Schultz' average diameter), which is intermediate between the average diameter in number and the average diameter in volume extracted from the same Zimm-Schultz distribution model.

### Determination of the Amount of Aluminium W_{Al}

The weight amount of aluminium, based on the weight amount of SiO₂, was measured using XRF wavelength dispersive X-ray fluorescence spectrometry using a WDXRF Panalytical instrument. Sample analyses were performed under helium in a 4 cm diameter cell using silica, especially silica powder, contained in the cell covered by a thin Prolene film (4 μm Chemplex®) over a range Al/SiO₂ of from 0.1 to 3.0% (in weight).

Al and Si fluorescence were measured using the following parameters: Al Kα angle 2θ=144.94680 (20 s), background signal angle 2θ=−1.2030° (4s), Si Kα angle 2θ=109.11520 (10 s), tube power 4 kW (32 kV, 125 mA), PE002 crystal and 550 μm collimator, gas flux detector.

The weight amount of aluminium in precipitated silica samples containing over 3.0% Al/SiO₂ was determined by means of ICP OES (inductively coupled plasma optical emission spectrometery). A precipitated silica sample was digested in fluorhydric acid (e.g. about 0.2-0.3 g of precipitated silica with 1 mL of fluorhydric acid at 40% concentration). A limpid solution was obtained, which was diluted in a 5% nitric acid aqueous solution according to the expected Al concentration. The intensity measured at the Al specific wavelength (396.152 nm) was compared to a calibration curve in the range of from 0.05 to 2.00 mg/L obtained using aluminium standards (4 standards at 0.10, 0.20, 1.00 and 2.00 mg/L) in similar analytical conditions. The weight content of aluminium in the precipitated silica sample was calculated using the dilution factor. The weight amount of aluminium, based on the weight amount of SiO₂, of the precipitated silica sample was then calculated from the weight content of aluminium and the weight content of water moisture in the precipitated silica sample, considering that said precipitated silica sample consisted essentially of SiO₂ (typically from about 95 to about 99 wt %) and of water moisture (typically from about 5 to about 1 wt %).

### Determination of Water Moisture

The water moisture content of silica samples, especially of silica samples containing over 3.0% Al/SiO₂, was determined on the basis of ISO 787-2. The silica volatile portions (herein referred to as water moisture for simplicity) were determined after 2 hours of drying at 105° C. This drying loss mainly consisted essentially of water moisture.

10 g of powdery silica, spherical silica (micropearls) or granular silica were weighed precisely to 0.1 mg (weighed sample E) into a dry weighing bottle with ground glass cover (diameter 8 cm, height 3 cm). The sample was dried with the lid open for 2 h at 105±2° C. in a drying cabinet. The weighing bottle was then closed and cooled to room temperature in a desiccator with silica gel as a drying agent. The weighed portion A was determined gravimetrically. The water moisture was determined in % according to [(E in g−A in g)*100%]/(E in g)

### EXAMPLES

### Examples 1 to 14: Synthesis of Silica

### Example 1 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.47; SiO₂ concentration=19.9 wt %) at a flowrate of 103.2 g/min and a 7.7 wt % sulfuric acid solution at a flowrate of 102.9 g/min were introduced simultaneously over a period of 2.9 min. The same sodium silicate solution was used throughout the process. Then, a sulfuric acid was introduced into the reactor to reach a pH value of 4.25. Next, a sodium silicate solution at a flowrate of 105 g/min and a 7.7 wt % sulfuric acid solution at a flowrate of 123.3 g/min were simultaneously introduced over a period of 12.2 min. The flowrate of sulfuric acid was regulated so that the pH of the reaction medium was maintained at a value of 4.25. At the end of this step, sodium silicate at a flowrate of 104.3 g/min and a 96 wt % sulfuric acid solution were introduced simultaneously over a period 10.05 min. The flowrate of the 96 wt % sulfuric acid solution was regulated so that the pH of the reaction medium was maintained at a value of 4.25.

The introduction of acid was then stopped while the addition of sodium silicate was maintained at the flowrate of 118.5 g/min over a period of 2.4 min until the reaction medium reached the pH value of 8.00.

Sodium silicate at a flowrate of 164.3 g/min and a 96 wt % sulfuric acid solution were then introduced simultaneously over a period of 18.05 min. The flowrate of the 96 wt % sulfuric acid solution was regulated so that the pH of the reaction medium was maintained at a value of 8.00.

At the end of this simultaneous addition, the pH of the reaction medium was brought to a value of 4.6 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S1.

The properties of precipitated silica S1 are reported in Table I.

### Example 2 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.46; SiO₂ concentration=19.33 wt %) at a flowrate of 104.5 g/min and a 7.7 wt % sulfuric acid solution at a flowrate of 113.6 g/min were introduced simultaneously over a period of 3.8 min. The same sodium silicate solution was used throughout the process. Then, a sulfuric acid was introduced into the reactor to reach a pH value of 4.08. Next, a sodium silicate solution at a flowrate of 108.3 g/min and a 7.7 wt % sulfuric acid solution at a flowrate of 124.4 g/min were simultaneously introduced over a period of 11.35 min. The flowrate of sulfuric acid was regulated so that the pH of the reaction medium was maintained at a value of 4.08. At the end of this step, sodium silicate at a flowrate of 108.1 g/min and a 96 wt % sulfuric acid solution were introduced simultaneously over a period 5.05 min. The flowrate of the 96 wt % sulfuric acid solution was regulated so that the pH of the reaction medium was maintained at a value of 4.08.

The introduction of acid was then stopped while the addition of sodium silicate was maintained at the flowrate of 121.9 g/min over a period of 2.8 min until the reaction medium reached the pH value of 8.00.

Sodium silicate at a flowrate of 169.1 g/min and a 96 wt % sulfuric acid solution were then introduced simultaneously over a period of 21.71 min. The flowrate of the 96 wt % sulfuric acid solution was regulated so that the pH of the reaction medium was maintained at a value of 8.00.

At the end of this simultaneous addition, the pH of the reaction medium was brought to a value of 4.33 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S2.

The properties of precipitated silica S2 are reported in Table I.

### Example 3 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.46; SiO₂ concentration=19.33 wt %) at a flowrate of 106.2 g/min and a 7.7 wt % sulfuric acid solution at a flowrate of 112.8 g/min were introduced simultaneously over a period of 4.7 min. The same sodium silicate solution was used throughout the process. Then, a sulfuric acid was introduced into the reactor to reach a pH value of 4.43. Then, a sodium silicate solution at a flowrate of 107.8 g/min and a 7.7 wt % sulfuric acid solution at a flowrate of 122.3 g/min were simultaneously introduced over a period of 10.55 min. The flowrate of sulfuric acid was regulated so that the pH of the reaction medium was maintained at a value of 4.43. At the end of this step, sodium silicate at a flowrate of 108.5 g/min and a 96 wt % sulfuric acid solution were introduced simultaneously over a period 9.95 min. The flowrate of the 96 wt % sulfuric acid solution was regulated so that the pH of the reaction medium was maintained at a value of 4.43.

The introduction of acid was then stopped while the addition of sodium silicate was maintained at the flowrate of 125.9 g/min over a period of 3 min until the reaction medium reached the pH value of 8.00.

Sodium silicate at a flowrate of 169.1 g/min and a 96 wt % sulfuric acid solution were then introduced simultaneously over a period of 18.10 min. The flowrate of the 96 wt % sulfuric acid solution was regulated so that the pH of the reaction medium was maintained at a value of 8.00.

At the end of this simultaneous addition, the pH of the reaction medium was brought to a value of 4.45 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S3.

The properties of precipitated silica S3 are reported in Table I.

### Example 4 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.46; SiO₂ concentration=19.33 wt %) at a flowrate of 105.6 g/min and a 7.7 wt % sulfuric acid solution at a flowrate of 110.8 g/min were introduced simultaneously over a period of 4.71 min. The same sodium silicate solution was used throughout the process. Then, a sulfuric acid was introduced into the reactor to reach a pH value of 4.08. Then, a sodium silicate solution at a flowrate of 105.6 g/min and a 7.7 wt % sulfuric acid solution at a flowrate of 124.3 g/min were simultaneously introduced over a period of 10.45 min. The flowrate of sulfuric acid was regulated so that the pH of the reaction medium was maintained at a value of 4.08. At the end of this step, sodium silicate at a flowrate of 108.5 g/min and a 96 wt % sulfuric acid solution were introduced simultaneously over a period 10 min. The flowrate of the 96 wt % sulfuric acid solution was regulated so that the pH of the reaction medium was maintained at a value of 4.08.

The introduction of acid was then stopped while the addition of sodium silicate was maintained at the flowrate of 124.4 g/min over a period of 3.45 min until the reaction medium reached the pH value of 8.00.

Sodium silicate at a flowrate of 169.3 g/min and a 96 wt % sulfuric acid solution were then introduced simultaneously over a period of 18.07 min. The flowrate of the 96 wt % sulfuric acid solution was regulated so that the pH of the reaction medium was maintained at a value of 8.00.

At the end of this simultaneous addition, the pH of the reaction medium was brought to a value of 4.6 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S4.

The properties of precipitated silica S4 are reported in Table I.

### Example 5 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.46; SiO₂ concentration=19.33 wt %) at a flowrate of 104.1 g/min and a 7.7 wt % sulfuric acid solution at a flowrate of 109.4 g/min were introduced simultaneously over a period of 4.05 min. The same sodium silicate solution was used throughout the process. Then, a sulfuric acid was introduced into the reactor to reach a pH value of 3.8. Next, a sodium silicate solution at a flowrate of 108.3 g/min and a 7.7 wt % sulfuric acid solution at a flowrate of 126.3 g/min were simultaneously introduced over a period of 11.12 min. The flowrate of sulfuric acid was regulated so that the pH of the reaction medium was maintained at a value of 3.8. At the end of this step, sodium silicate at a flowrate of 108.1 g/min and a 96 wt % sulfuric acid solution were introduced simultaneously over a period 10 min. The flowrate of the 96 wt % sulfuric acid solution was regulated so that the pH of the reaction medium was maintained at a value of 3.8.

The introduction of acid was then stopped while the addition of sodium silicate was maintained at the flowrate of 123.4 g/min over a period of 2.7 min until the reaction medium reached the pH value of 8.00.

Sodium silicate at a flowrate of 169.4 g/min and a 96 wt % sulfuric acid solution were then introduced simultaneously over a period of 18.07 min. The flowrate of the 96 wt % sulfuric acid solution was regulated so that the pH of the reaction medium was maintained at a value of 8.00.

At the end of this simultaneous addition, the pH of the reaction medium was brought to a value of 4.53 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S5.

The properties of precipitated silica S5 are reported in Table I.

### Example 6 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium.

A sodium silicate solution (SiO₂/Na₂O weight ratio=3.46; SiO₂ concentration=19.33 wt %) at a flowrate of 105.8 g/min and a 7.7 wt % sulfuric acid solution at a flowrate of 107.6 g/min were introduced simultaneously over a period of 3.75 min. The same sodium silicate solution was used throughout the process. Then, a sulfuric acid was introduced into the reactor to reach a pH value of 4.43. Next, a sodium silicate solution at a flowrate of 108.08 g/min and a 7.7 wt % sulfuric acid solution at a flowrate of 122.9 g/min were simultaneously introduced over a period of 11.4 min. The flowrate of sulfuric acid was regulated so that the pH of the reaction medium was maintained at a value of 4.43. At the end of this step, sodium silicate at a flowrate of 107.8 g/min and a 96 wt % sulfuric acid solution were introduced simultaneously over a period 5 min. The flowrate of the 96 wt % sulfuric acid solution was regulated so that the pH of the reaction medium was maintained at a value of 4.43.

The introduction of acid was then stopped while the addition of sodium silicate was maintained at the flowrate of 120.5 g/min over a period of 2.1 min until the reaction medium reached the pH value of 8.00.

Sodium silicate at a flowrate of 169.4 g/min and a 96 wt % sulfuric acid solution were then introduced simultaneously over a period of 21.7 min. The flowrate of the 96 wt % sulfuric acid solution was regulated so that the pH of the reaction medium was maintained at a value of 8.00.

At the end of this simultaneous addition, the pH of the reaction medium was brought to a value of 4.6 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica S6.

The properties of precipitated silica S6 are reported in Table I.

### Comparative Example 7

In a 25 L stainless steel reactor were introduced: 15.2 L of usual water and 356 g of Na₂SO₄ (solid). The solution obtained was stirred and heated to reach 92° C. The entire reaction was carried out at this temperature and under stirring to maintain a homogeneous reaction medium. Sulfuric acid (concentration: 7.7 wt %) was introduced into the reactor to reach a pH value of 4.43

A sodium silicate solution (SiO₂/Na₂O weight ratio=3.46; SiO₂ concentration=19.33 wt %) at a flowrate of 88.8 g/min was introduced in the reactor over a period of 45 s. The same sodium silicate solution was used throughout the process. Then, a sulfuric acid was introduced into the reactor to reach a pH value of 4.43. Next, a sodium silicate solution at a flowrate of 111.8 g/min and a 7.7 wt % sulfuric acid solution at a flowrate of 123.6 g/min were simultaneously introduced over a period of 14.97 min. The flowrate of sulfuric acid was regulated so that the pH of the reaction medium was maintained at a value of 4.42. At the end of this step, sodium silicate at a flowrate of 109.3 g/min and a 96 wt % sulfuric acid solution were introduced simultaneously over a period of 9.85 min. The flowrate of the 96 wt % sulfuric acid solution was regulated so that the pH of the reaction medium was maintained at a value of 4.42.

The introduction of acid was then stopped while the addition of sodium silicate was maintained at the flowrate of 118.9 g/min over a period of 2.4 min until the reaction medium reached the pH value of 8.00.

Sodium silicate at a flowrate of 166.3 g/min and a 96 wt % sulfuric acid solution were then introduced simultaneously over a period of 18.22 min. The flowrate of the 96 wt % sulfuric acid solution was regulated so that the pH of the reaction medium was maintained at a value of 8.00.

At the end of this simultaneous addition, the pH of the reaction medium was brought to a value of 4.6 with 96 wt % sulfuric acid. The reaction mixture was matured for 5 minutes. A slurry was obtained.

The reaction slurry was filtered and washed on a filter press. The cake obtained was disintegrated mechanically and chemically by addition of about 0.30 wt %, with respect to the weight of SiO₂, of aluminium metal Al in the form of an aluminate solution ([Al]: 11.6 wt %, [Na₂O]: 19.9 wt %), targeting an Al/SiO₂ weight ratio of about 0.33 wt % (it being understood that about 0.03 wt % Al originated from the silicate solution). The flowrate of the 7.7 wt % sulfuric acid solution was regulated so that the pH of the reaction medium was maintained at a value of 6.3. The resulting slurry was dried by means of a nozzle spray dryer to obtain precipitated silica CS7.

The properties of precipitated silica CS7 are reported in Table

### Comparative Example 8 (in Accordance with WO 2018/202752)

In a 2500 L stainless steel reactor were introduced 1126 L of water and 29.7 kg of Na₂SO₄ (solid). The obtained solution was stirred and heated to reach 92° C. The entire reaction was carried out at this temperature. A 96 wt % sulfuric acid solution was introduced into the reactor to reach a pH value of 3.9. A sodium silicate solution (SiO₂/Na₂O ratio=3.45, SiO₂ concentration=19.3 wt %) at a flowrate of 420 L/h was introduced in the reactor over a period of 51 s. The same sodium silicate solution was used throughout the process. Next, a sodium silicate solution at a flowrate of 445 L/h, water at a flowrate of 575 L/h and a 96 wt % sulfuric acid solution were simultaneously introduced over 14.9 min period. The flowrate of sulfuric acid was regulated so that the pH of the reaction medium was maintained at a value of 4.3. At the end of this step, sodium silicate solution at a flowrate of 445 L/h and a 96 wt % sulfuric acid solution were introduced simultaneously over a period of 9.45 min. The 96 wt % sulfuric acid solution flowrate was regulated so that the pH of the reaction medium was maintained at a value of 4.3.

The introduction of acid was then stopped while the addition of sodium silicate solution was put at the flowrate of 579 L/h until the reaction medium reached the pH value of 8.00.

Sodium silicate solution at a flowrate of 708 L/h and a 96 wt % sulfuric acid solution were then introduced simultaneously over a period of 3 min. The flowrate of the 96 wt % sulfuric acid solution was regulated so that the pH of the reaction medium was maintained at a value of 8.00.

Simultaneously, over a period of 14.8 min, were introduced: sodium silicate solution at a flowrate of 706 I/h, a sodium aluminate solution (Al: 12.2 wt %, Na₂0: 19.4 wt %) at a flowrate of 47.6 kg/h and a 96% sulfuric acid solution; the sodium aluminate solution was added in an amount so as to target an Al/SiO₂ weight ratio of about 1.40 wt % (it being understood that about 0.03 wt % Al originated from the silicate solution).

The flowrate of the 96% sulfuric acid solution was regulated so that the pH of the reaction medium was maintained at a value of 8.0.

At the end of this simultaneous addition, the pH of the reaction medium was brought to a value of 4.4 with 96 wt % sulfuric acid. Then, water was introduced to decrease the temperature to 85° C. and the reaction mixture was matured for 5 minutes. A slurry was obtained.

The reaction slurry was filtered and washed on a filter press to give a precipitated silica cake with a solid content of 23% by weight.

Silica cake obtained was then subjected to a liquefaction step in a continuous vigorously stirred reactor. 200 g of 7.7% sulfuric acid solution were then added to the mix to adjust the pH. The pH value of the liquefied cake was 6.0 and it had a solid content of 23% by weight.

The resulting slurry was dried by means of a nozzle spray dryer to obtain precipitated silica micropearls CS8.

The properties of precipitated silica CS8 are reported in Table I.

### Comparative Example 9 (in Accordance with WO 2009/112458)

In a 25 L stainless steel reactor were introduced: 9.26 L of usual water, 136.6 g of Na₂SO₄ (solid) and 4756 g of a sodium silicate solution (SiO₂/Na₂O weight ratio=3.46, SiO₂ concentration=19.95 wt %). The solution was stirred and heated to reach 92.5° C. The entire reaction was carried out at this temperature and under stirring to maintain a homogeneous reaction medium.

A 7.7 wt % sulfuric acid solution at a flowrate of 110.7 g/min was introduced over a period of 17 min. Then, the flowrate of a 7.7 wt % sulfuric acid solution was adjusted to 321.0 g/min to reach the pH of the reaction medium which was set to a value of 8.0.

A sodium silicate solution at a flowrate of 95.3 g/min and a 7.7 wt % sulfuric acid solution were then introduced simultaneously over a period of 10 min. The flowrate of the 7.7 wt % sulfuric acid solution was regulated so that the pH of the reaction medium was maintained at a value of 8.00.

At the end of this step the pH of the reaction medium was brought to a value of 4.05 with 7.7 wt % sulfuric acid over a period of 8 min.

Sodium silicate solution at a flowrate of 64.3 g/min and a 7.7 wt % sulfuric acid solution were then introduced simultaneously over a period of 28 min. The flowrate of the 7.7 wt % sulfuric acid solution was regulated so that the pH of the reaction medium was maintained at a value of 4.05.

The introduction of acid was then stopped while the addition of sodium silicate solution was maintained at the flowrate of 29 g/min over a period of 4.6 min until the reaction medium reached the pH value of 5.2. The reaction mixture was matured for 5 minutes. A slurry was obtained.

The slurry was filtered and washed on a filter press to give a precipitated silica cake with a solid content of 20% by weight. Silica cake obtained was then subjected to a liquefaction step in a continuous vigorously stirred reactor with addition of a sodium aluminate solution ([Al]: 11.6 wt %-[Na₂O]: 19.9 wt %) and sulfuric acid solution at 7.7 wt % to adjust the pH. The sodium aluminate solution was added in an amount so as to target an Al/SiO₂ weight ratio of about 0.33 wt % (it being understood that about 0.03 wt % Al originated from the silicate solution). The pH value of the liquefied cake was 6.4 and the cake had a solid content of 20%. The resulting slurry was dried by means of a nozzle spray dryer to obtain a precipitated silica powder.

Then, a granulation step was carried out. 150 g of the silica powder were used by batch; they were introduced in a granulator (Alexanderwerk, granulator WP 120 Pharma). Silica granules were formed by using an air gap of 3 mm, a hydraulic pressure of 20 bars and a roller speed between 3 and 5 rpm. The speed of the granulator was fixed at 108 rpm and a sieving between 1 and 2.5 mm was achieved. The duration of the granulation step was around 15 min by batch. Precipitated silica granules CS9 were thus obtained.

The properties of precipitated silica CS9 are reported in Table I.

### Example 10 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium. A sodium silicate solution (SiO₂/Na₂O weight ratio=3.46, SiO₂ concentration=19.33 wt %) at a flowrate of 102.7 g/min and a 7.7 wt % sulfuric acid solution at a flowrate of 28.3 g/min were simultaneously introduced over a period of 3.74 min The flowrate of sulfuric acid was regulated so that the pH of the reaction medium was set to a value of 8.0 Let us name “AS0” this step.

After this step, a 7.7% wt sulfuric acid solution was introduced into the reactor to reach a pH value of 4.2. Then, a sodium silicate solution at a flowrate of 105.1 g/min and a 7.7 wt % sulfuric acid solution at a flowrate of 122.3 g/min were simultaneously introduced over a period of 11.55 min. The flowrate of sulfuric acid was regulated so that the pH of the reaction medium was set to a value of 4.2. At the end of this step, sodium silicate solution at a flowrate of 104.9 g/min and a 96 wt % sulfuric acid solution were introduced simultaneously over a period of 4.85 min. The flowrate of the 96 wt % sulfuric acid solution was regulated so that the pH of the reaction medium was maintained at a value of 4.2. The point of gel was observed during this step after 2.15 min. The silicate added after the point of gel was equal to 13% of the total silicate added since the beginning of the reaction.

The introduction of acid was then stopped while the addition of sodium silicate solution was maintained at the flowrate of 146.8 g/min over a period of 2.00 min until the reaction medium reached the pH value of 8.00.

Sodium silicate solution at a flowrate of 163.3 g/min and a 96 wt % sulfuric acid solution were then introduced simultaneously over a period of 21.73 min. The flowrate of the 96 wt % sulfuric acid solution was regulated so that the pH of the reaction medium was maintained at a value of 8.00.

At the end of this step the pH of the reaction medium was brought to a value of 4.8 with 96 wt % sulfuric acid. The reaction mixture was matured for 5 minutes. A slurry was obtained.

The slurry was filtered and washed on a filter press to give a precipitated silica cake with a solid content of 20% by weight. Silica cake obtained was then subjected to a liquefaction step in a continuous vigorously stirred reactor with addition of a sodium aluminate solution ([Al]: 11.6 wt %-[Na₂O]: 19.9 wt %) and sulfuric acid solution at 7.7 wt % to adjust the pH. The sodium aluminate solution was added in an amount so as to target an Al/SiO₂ weight ratio of about 0.18 wt % (it being understood that about 0.03 wt % Al originated from the silicate solution). The pH value of the liquefied cake was 6.4 and a solid content of 20%. The resulting slurry was dried by means of a nozzle spray dryer to obtain a precipitated silica powder.

Then, a granulation step was carried out. 150g of the silica powder were used by batch; they were introduced in a granulator (Alexanderwerk, granulator WP 120 Pharma). Silica granules were formed by using an air gap of 3 mm, a hydraulic pressure of 20 bars and a roller speed between 3 and 5 rpm. The speed of the granulator was fixed at 108 rpm and a sieving between 1 and 2.5 mm was achieved. The duration of the granulation step was around 15 min by batch. Precipitated silica granules S10 were thus obtained.

The properties of precipitated silica S10 are reported in Table I.

### Example 11 (According to the Invention)

In a 25 L stainless steel reactor were introduced: 15.3 L of usual water and 359 g of Na₂SO₄ (solid). The solution obtained was stirred and heated to reach 92° C. The entire reaction was carried out at this temperature and under stirring to maintain a homogeneous reaction medium. A sodium silicate solution (SiO₂/Na₂O weight ratio=3.46, SiO₂ concentration=19.33 wt %) at a flowrate of 102.7 g/min and a 7.7 wt % sulfuric acid solution at a flowrate of 28.3 g/min were simultaneously introduced over a period of 3.74 min. The flowrate of sulfuric acid was regulated so that the pH of the reaction medium was set to a value of 8.0. This step will be named AS0. After this step, a 7.7% wt sulfuric acid solution was introduced into the reactor to reach a pH value of 4.2. Then, a sodium silicate solution at a flowrate of 105.1 g/min and a 7.7 wt % sulfuric acid solution at a flowrate of 122.3 g/min were simultaneously introduced over a period of 11.55 min. The flowrate of sulfuric acid was regulated so that the pH of the reaction medium was set to a value of 4.2. At the end of this step, sodium silicate solution at a flowrate of 104.9 g/min and a 96 wt % sulfuric acid solution were introduced simultaneously over a period of 4.85 min. The flowrate of the 96 wt % sulfuric acid solution was regulated so that the pH of the reaction medium was maintained at a value of 4.2. The point of gel was observed during this step after 2.15 min. The silicate added after the point of gel was equal to 13% of the total silicate added since the beginning of the reaction.

The introduction of acid was then stopped while the addition of sodium silicate solution was maintained at the flowrate of 146.8 g/min over a period of 2.00 min until the reaction medium reached the pH value of 8.00.

Sodium silicate solution at a flowrate of 163.3 g/min and a 96 wt % sulfuric acid solution were then introduced simultaneously over a period of 21.73 min. The flowrate of the 96 wt % sulfuric acid solution was regulated so that the pH of the reaction medium was maintained at a value of 8.00.

At the end of this step the pH of the reaction medium was brought to a value of 4.8 with 96 wt % sulfuric acid. The reaction mixture was matured for 5 minutes. A slurry was obtained.

The slurry was filtered and washed on a filter press to give a precipitated silica cake with a solid content of 20% by weight. Silica cake obtained was then subjected to a liquefaction step in a continuous vigorously stirred reactor with addition of a sodium aluminate solution ([Al]: 11.6 wt %-[Na₂O]: 19.9 wt %) and sulfuric acid solution at 7.7% wt % to adjust the pH. The sodium aluminate solution was added in an amount so as to target an Al/SiO₂ weight ratio of about 1.1-1.2 wt %. The pH value of the liquefied cake was 6.4 and a solid content of 20%. The resulting slurry was dried by means of a nozzle spray dryer to obtain a precipitated silica powder.

Then, a granulation step was carried out. 150g of the silica powder were used by batch; they were introduced in a granulator (Alexanderwerk, granulator WP 120 Pharma). Silica granules were formed by using an air gap of 3 mm, a hydraulic pressure of 20 bars and a roller speed between 3 and 5 rpm. The speed of the granulator was fixed at 108 rpm and a sieving between 1 and 2.5 mm was achieved. The duration of the granulation step was around 15 min by batch. Precipitated silica granules S11 were thus obtained.

The properties of precipitated silica S11 are reported in Table I.

### Example 12 (According to the Invention)

In a 2500 L stainless steel reactor were introduced 1124 L of water and 29.8 kg of Na₂SO₄ (solid). The obtained solution was stirred and heated to reach 92° C. The entire reaction was carried out at this temperature.

A sodium silicate solution (SiO₂/Na₂O ratio=3.45, SiO₂ concentration=18.8 wt %) at a flowrate of 436 L/h, water at a flowrate of 582 L/h and a 96 wt % sulfuric acid solution were simultaneously introduced over 6.2 min period. The flowrate of sulfuric acid was regulated so that the pH of the reaction medium was maintained at a value of 8.2.

The introduction of sodium silicate solution was then stopped until the reaction medium reached the pH value of 3.8.

Then, a sodium silicate solution at a flowrate of 445 L/h, water at a flowrate of 575 L/h and a 96 wt % sulfuric acid solution were simultaneously introduced over 7.1 min period. The flowrate of sulfuric acid was regulated so that the pH of the reaction medium was maintained at a value of 3.8. At the end of this step, sodium silicate solution at a flowrate of 445 L/h and a 96 wt % sulfuric acid solution were introduced simultaneously over a period of 6.1 min. The 96 wt % sulfuric acid solution flowrate was regulated so that the pH of the reaction medium was maintained at a value of 3.8.

The gel point was about 11 min. During all this step of simultaneous addition of sodium silicate solution and acid, the quantity of sodium silicate added after gel point represented 53% of total quantity added during this step.

The introduction of acid was then stopped while the addition of sodium silicate solution was put at the flowrate of 622 L/h until the reaction medium reached the pH value of 8.00.

Sodium silicate solution at a flowrate of 706 L/h and a 96 wt % sulfuric acid solution were then introduced simultaneously over a period of 22.4 min. The flowrate of the 96 wt % sulfuric acid solution was regulated so that the pH of the reaction medium was maintained at a value of 8.00.

At the end of this simultaneous addition, the pH of the reaction medium was brought to a value of 4.9 with 96 wt % sulfuric acid. Then, water was introduced to decrease the temperature to 85° C. and the reaction mixture was matured for 5 minutes. A slurry was obtained.

Each reaction slurry was filtered and washed on a filter press to give a precipitated silica cake with a solid content of 23% by weight.

Silica cake obtained was then subjected to a liquefaction step in a continuous vigorously stirred reactor with addition of a sodium aluminate solution ([Al]: 12.5 wt %-[Na₂O]: 19.5 wt %) and sulfuric acid solution at 7.7 wt % to adjust the pH. The sodium aluminate solution was added in an amount so as to target an Al/SiO₂ weight ratio of about 0.33 wt % (it being understood that about 0.03 wt % Al originated from the silicate solution). The pH value of the liquefied cake was 6.3 and a solid content of 23% by weight.

The resulting slurry was dried by means of a nozzle spray dryer to obtain precipitated silica micropearls S12.

The properties of precipitated silica S12 are reported in Table I.

### Example 13 (According to the Invention)

In a 2500 L stainless steel reactor were introduced 1126 L of water and 29.8 kg of Na₂SO₄ (solid). The obtained solution was stirred and heated to reach 92° C. The entire reaction was carried out at this temperature.

A sodium silicate solution (SiO₂/Na₂O ratio=3.45; SiO₂ concentration=19.3 wt %) at a flowrate of 434 L/h, water at a flowrate of 586 L/h and a 96 wt % sulfuric acid solution were simultaneously introduced over 3.7 min period. The flowrate of sulfuric acid was regulated so that the pH of the reaction medium was maintained at a value of 8.4.

The introduction of sodium silicate solution was then stopped until the reaction medium reached the pH value of 3.9.

Next, a sodium silicate solution at a flowrate of 445 L/h, water at a flowrate of 567 L/h and a 96 wt % sulfuric acid solution were simultaneously introduced over 9.8 min period. The flowrate of sulfuric acid was regulated so that the pH of the reaction medium was maintained at a value of 3.9. At the end of this step, sodium silicate solution at a flowrate of 445 L/h and a 96 wt % sulfuric acid solution were introduced simultaneously over a period of 5.9 min. The 96 wt % sulfuric acid solution flowrate was regulated so that the pH of the reaction medium was maintained at a value of 3.9.

The gel point was about 15.3 min. During all this step of simultaneous addition of sodium silicate and acid, the quantity of sodium silicate added after gel point represented 29% of total quantity added during this step.

The introduction of acid was then stopped while the addition of sodium silicate solution was put at the flowrate of 618 L/h until the reaction medium reached the pH value of 8.00.

Sodium silicate solution at a flowrate of 705 L/h and a 96 wt % sulfuric acid solution were then introduced simultaneously over a period of 22.4 min. The flowrate of the 96 wt % sulfuric acid solution was regulated so that the pH of the reaction medium was maintained at a value of 8.00.

At the end of this simultaneous addition, the pH of the reaction medium was brought to a value of 4.8 with 96 wt % sulfuric acid. Then water was introduced to decrease the temperature to 85° C. and the reaction mixture was matured for 5 minutes. A slurry was obtained.

Each reaction slurry was filtered and washed on a filter press to give a precipitated silica cake with a solid content of 23% by weight.

Silica cake obtained was then subjected to a liquefaction step in a continuous vigorously stirred reactor with addition of a sodium aluminate solution ([Al]: 12.5 wt %-[Na₂O]: 19.5 wt %) and sulfuric acid solution at 7.7 wt % to adjust the pH. The sodium aluminate solution was added in an amount so as to target an Al/SiO₂ weight ratio of about 0.50 wt % (it being understood that about 0.03 wt % Al originated from the silicate solution). The pH value of the liquefied cake was 6.4 and a solid content of 23% by weight.

The resulting slurry was dried by means of a nozzle spray dryer to obtain precipitated silica micropearls S13.

The properties of precipitated silica S13 are reported in Table I.

### Example 14 (According to the Invention)

In a 2500 L stainless steel reactor were introduced 1124 L of water and 29.7 kg of Na₂SO₄ (solid). The obtained solution was stirred and heated to reach 92° C. The entire reaction was carried out at this temperature.

A sodium silicate solution (SiO₂/Na₂O ratio=3.45; SiO₂ concentration=19.3 wt %) at a flowrate of 445 L/h, a water flowrate of 575 L/h and a 96 wt % sulfuric acid solution were simultaneously introduced over 6.2 min period. The flowrate of sulfuric acid was regulated so that the pH of the reaction medium was maintained at a value of 8.2.

The introduction of sodium silicate solution was then stopped until the reaction medium reached the pH value of 4.0.

Then, a sodium silicate solution at a flowrate of 445 L/h, a water flowrate of 575 L/h and a 96 wt % sulfuric acid solution were simultaneously introduced over 7.1 min period. The flowrate of sulfuric acid was regulated so that the pH of the reaction medium was maintained at a value of 3.85. At the end of this step, sodium silicate solution at a flowrate of 445 L/h and a 96 wt % sulfuric acid solution were introduced simultaneously over a period of 6 min. The 96 wt % sulfuric acid solution flowrate was regulated so that the pH of the reaction medium was maintained at a value of 3.85.

The introduction of acid was then stopped while the addition of sodium silicate solution was put at the flowrate of 610 L/h until the reaction medium reached the pH value of 8.00.

Sodium silicate solution at a flowrate of 705 L/h and a 96 wt % sulfuric acid solution were then introduced simultaneously over a period of 22.4 min. The flowrate of the 96 wt % sulfuric acid solution was regulated so that the pH of the reaction medium was maintained at a value of 8.00.

At the end of this simultaneous addition, the pH of the reaction medium was brought to a value of 4.80 with 96 wt % sulfuric acid. Then water was introduced to decrease the temperature to 85° C. and the reaction mixture was matured for 5 minutes. A slurry was obtained.

Each reaction slurry was filtered and washed on a filter press to give a precipitated silica cake with a solid content of 23% by weight.

Silica cake obtained was then subjected to a liquefaction step in a continuous vigorously stirred reactor with addition of a sodium aluminate solution ([Al]: 12.5 wt %-[Na₂O]: 19.5 wt %) and sulfuric acid solution at 7.7 wt % to adjust the pH. The sodium aluminate solution was added in an amount so as to target an Al/SiO₂ weight ratio of about 1.20 wt % (it being understood that about 0.55 wt % Al originated from the silicate solution). The pH value of the liquefied cake was 6.4 and a solid content of 23% by weight.

The resulting slurry was dried by means of a nozzle spray dryer to obtain precipitated silica micropearls S14.

The properties of precipitated silica S14 are reported in Table I.

TABLE I

| | | | | | | | | | Formula | AS0 | Primary |
|---|---|---|---|---|---|---|---|---|---|---|---|
| | CTAB | BET | d₅₀ | d₈₄ | FWHM | | Tf | W_{Al} | FWHM: −0.16 × | silicate | particles |
| Products | (m²/g) | (m²/g) | (nm) | (nm) | (nm) | L_{d} | (%) | (%) | \|CTAB\| + 130 | ratio (%) | size (nm) |
| S1 | 163 | 194 | 160 | 361 | 154 | 1.8 | 97 | — | 104 | 5.3 | 6-10 |
| S2 | 163 | 180 | 147 | 332 | 148 | 1.8 | 98 | — | 104 | 6.8 | 8 |
| S3 | 130 | 151 | 213 | 481 | 207 | 1.8 | 98 | — | 109 | 7.0 | 7 |
| S4 | 177 | 193 | 163 | 355 | 174 | 1.7 | 99 | — | 102 | 8.6 | 6-10 |
| S5 | 213 | 229 | 118 | 247 | 111 | 1.6 | 100 | — | 96 | 6.8 | 7.5 |
| S6 | 130 | 152 | 175 | 398 | 182 | 1.8 | 97 | — | 109 | 6.8 | 8.5 |
| CS7 | 162 | 190 | 134 | 335 | 105 | 2.0 | 88 | — | 104 | 0.0 | 7 |
| CS8 | 158 | 221 | 144 | 375 | 118 | 2.1 | 88 | 1.39 | 105 | 0.0 | 6.5 |
| Zeosil ® | 155 | 160 | 93 | 175 | 65 | 1.3 | 98 | 0.33 | 105 | — | 15 |
| 1165MP | | | | | | | | | | | |
| Zeosil ® | 190 | 203 | 109 | 233 | 87 | 1.5 | 93 | 0.33 | 100 | — | 7 |
| Premium | | | | | | | | | | | |
| 200MP | | | | | | | | | | | |
| CS9 | 165 | 200 | 157 | 336 | 130 | 1.6 | 96 | 0.35 | 104 | 0 | n.m.(*) |
| S10 | 163 | 180 | 138 | 324 | 122 | 1.8 | 97 | 0.21 | 104 | 6.9 | 9 |
| S11 | 158 | 175 | 146 | 317 | 118 | 1.8 | 97 | 1.06 | 105 | 6.9 | 9 |
| S12 | 154 | 178 | 141 | 317 | 128 | 1.7 | 96 | 0.34 | 105 | 10.6 | — |
| S13 | 171 | 191 | 122 | 277 | 105 | 1.7 | 96 | 0.52 | 103 | 6.3 | 6-10 |
| S14 | 161 | 177 | 142 | 314 | 138 | 1.7 | 99 | 0.56 | 104 | 9.9 | 8 |

(*)n.m. = not measurable: no d_{ZS} could be determined for this sample because its SAXS profile F(q) exhibited no maximum

### Example 15: Use of Silica in Elastomeric Compositions

### Materials

A silica S2 according to the invention was evaluated in a SBR/BR model tire tread compound, in comparison with a silica obtained according to WO 03/016215 in the name of the Applicant (namely silica CS7 as described in Comparative Example 7 above). The compositions, expressed as parts by weight per 100 parts of elastomers (phr), are described in Table II below.

TABLE II

| Composition/Silica | CS7 | S2 |
|---|---|---|
| SBR (1) | 80 | 80 |
| BR (2) | 20 | 20 |
| CS7 | 80 | |
| S2 | | 80 |
| TESPT (3) | 6.6 | 6.6 |
| Carbon black | 3.0 | 3.0 |
| Hydrocarbon resin (4) | 20 | 20 |
| stearic acid | 2.0 | 2.0 |
| 6-PPD (5) | 2.5 | 2.5 |
| ZnO | 1.2 | 1.2 |
| Sulfur | 1.0 | 1.0 |
| DPG (6) | 1.8 | 1.7 |
| CBS (7) | 2.3 | 2.3 |

(1) Oil extended solution SBR, Buna VSL4526-2HM from Lanxess with 45% of vinyl units; 26% of styrene units; Tg of −30° C., 37.5 phr of TDAE
(2) BR: Butyl Rubber Buna CB 25 from Lanxess
(3) TESPT: Bis[3-(triethoxysilyl)propyl] Tetrasulfide, TESPT Luvomaxx, from Lehmann&Voss&Co
(4) Hydrocarbon resin SYLVATRAXX 4101 from Arizona Chemical
(5) 6PPD: N-(1,3-Dimethylbutyl)-N-phenyl-para-phenylenediamine, Santoflex 6-PPD from Flexsys
(6) DPG: Diphenylguanidine, Rhenogran DPG-80 from RheinChemie
(7) CBS: N-Cyclohexyl-2-benzothiazolesulfenamide, Rhenogran CBS-80 from RheinChemie

### Process for the Preparation of the Rubber Compositions

The preparation of the rubber compositions was carried out in two successive preparation phases: a first phase of high-temperature thermomechanical working, followed by a second phase of mechanical working at temperatures of less than 110° C. to introduce the vulcanization system. The first phase was carried out using a mixing device, of internal mixer type, of Brabender brand (capacity of 380 mL).

In a first pass of the first phase the elastomers and the reinforcing filler (introduction in instalments) were mixed with the coupling agent, the plasticizers, the stearic acid, the 6-PPD, the DPG and the ZnO. The duration was 4 min 30 and the dropping temperature was about 160° C.

After cooling the mixture (temperature of less than 100° C.), the vulcanization system was added during the second phase. It was carried out on an open mill, preheated to 50° C. To ensure a good homogeneity of the vulcanization systems in the compound, 20 cuts were done. The duration of this phase was between 2 and 6 minutes. Each final mixture was subsequently calendered in the form of plaques with a thickness of 2-3 mm.

### Properties of the Vulcanisates

The measurements were carried out after vulcanization at 150° C. for 50 min.

The Z value was measured, after crosslinking, according to the method described by S. Otto and al. in Kautschuk Gummi Kunststoffe, 58 Jahrgang, NR 7-8/2005 in accordance with ISO 11345.

The percentage “area not dispersed” is calculated using a camera observing the surface of the sample in a 300 incident light. The bright points are associated with the charge and the agglomerates, while dark points are associated with the rubber matrix. A digital processing transforms the image into a black and white image, and allows the determination of the percentage “area not dispersed”, as described by S. Otto in the document cited above. The higher the Z value, the better dispersion of the charge in the elastomeric matrix (a Z value of 100 corresponding to a perfect dispersion and a Z value of 0 corresponds to a very bad dispersion).

The calculation of the Z value is based on the percentage area in which the charge is not dispersed as measured by the machine DisperGrader® 1000 supplied with its operative mode and its operating software DisperData by the company Dynisco according to equation: Z=100−(percent area not dispersed)/0.35

Uniaxial tensile tests were carried out in accordance with the instructions of the standard NF ISO 37 with test specimens of H2 type at a rate of 500 mm/min on an Instron 5564 device. The x % moduli, corresponding to the stress measured at x % of tensile strain, are expressed in MPa. The tensile strength is expressed in MPa; elongation at break is expressed in MPa.

A reinforcing index (RI) was determined which is equal to the ratio of the modulus at 300% strain to the modulus at 100% strain.

The values for the loss factor (tan δ) and amplitude of elastic modulus in dynamic shear (ΔG′) were recorded on vulcanized samples (parallelepiped specimen: cross section 8 mm² and height 7 mm). The sample is subjected to a double alternating sinusoidal shear strain at a temperature of 40° C. and at a frequency of 10 Hz. The strain amplitude sweeping processes were performed according to an outward-return cycle, proceeding outward from 0.1% to 50% and then returning from 50% to 0.1%. The values reported in Table III below are obtained from the return strain amplitude scanning and concern the maximum value of the loss factor (tan δmax). Measurements were performed on a Metravib DMA+1000.

All results are summarized in Table III below.

TABLE III

| Property/Silica | CS7 | S2 |
|---|---|---|
| Z index | 74 | 94 |
| Modulus 300 (MPa) | 10.2 | 9.4 |
| Reinforcement Index | 4.3 | 4.5 |
| Tensile strength | 19.2 | 20.3 |
| (MPa) | | |
| Elongation at | 485 | 514 |
| break (%) | | |
| Tan δ max | 0.238 | 0.259 |

The silica according to the invention presents an excellent dispersability, intermediate reinforcement index, tensile strength and elongation at break while keeping a low tan δ max; hence, it allows reaching a better wear/rolling resistance compromise

### Example 16: Use of Silica in Elastomeric Compositions

### Materials

Silicas S5, S10, S11, S12, S13 and S14 according to the invention were evaluated in a SBR/BR compound in comparison with:
2 silicas commercially available from SOLVAY SA, namely ZEOSIL® 1165 silica (in short, Z1165MP) and ZEOSIL® Premium 200MP silica (in short, ZP200MP), and
2 silicas in accordance with the teachings of various prior art patent applications, namely silicas CS8 and CS9.

Three formulations were used, as detailed in tables IV, V and VI below. The amount of the ingredients contained in the tested compositions were expressed as part(s) by weight per 100 parts of elastomers (phr).

TABLE IV

| Composition/Silica | Z1165MP | CS8 | CS9 | S10 | S11 | S12 |
|---|---|---|---|---|---|---|
| SBR (1) | 80 | 80 | 80 | 80 | 80 | 80 |
| BR (2) | 20 | 20 | 20 | 20 | 20 | 20 |
| Z1165MP | 80 | | | | | |
| CS8 | | 80 | | | | |
| CS9 | | | 80 | | | |
| S10 | | | | 80 | | |
| S 11 | | | | | 80 | |
| S12 | | | | | | 80 |
| TESPD (3) | 6.0 | 6.0 | 6.0 | 6.0 | 6.0 | 6.0 |
| Carbon black | 3.0 | 3.0 | 3.0 | 3.0 | 3.0 | 3.0 |
| Hydrocarbon resin (4) | 20 | 20 | 20 | 20 | 20 | 20 |
| stearic acid | 2.0 | 2.0 | 2.0 | 2.0 | 2.0 | 2.0 |
| 6-PPD (5) | 2.5 | 2.5 | 2.5 | 2.5 | 2.5 | 2.5 |
| ZnO | 1.2 | 1.2 | 1.2 | 1.2 | 1.2 | 1.2 |
| Sulfur | 1.7 | 1.7 | 1.7 | 1.7 | 1.7 | 1.7 |
| DPG (6) | 1.6 | 1.6 | 1.6 | 1.6 | 1.6 | 1.6 |
| CBS (7) | 2.3 | 2.3 | 2.3 | 2.3 | 2.3 | 2.3 |

(1) Oil extended solution SBR, Buna VSL4526-2HM from Lanxess with 45% of vinyl units; 26% of styrene units; Tg of −30° C., 37.5 phr of TDAE
(2) BR: Butyl Rubber Buna CB 25 from Lanxess
(3) TESPD: Bis[3-(triethoxysilyl)propyl] disulfide, TESPD Luvomaxx, from Lehmann & Voss & Co
(4) Hydrocarbon resin SYLVATRAXX 4101 from Arizona Chemical
(5) 6PPD: N-(1,3-Dimethylbutyl)-N-phenyl-para-phenylenediamine, Santoflex 6-PPD from Flexsys
(6) DPG: Diphenylguanidine, Rhenogran DPG-80 from RheinChemie
(7) CBS: N-Cyclohexyl-2-benzothiazolesulfenamide, Rhenogran CBS-80 from RheinChemie

TABLE V

| Composition/Silica | ZP200MP | S13 | S5 |
|---|---|---|---|
| SBR (1) | 80 | 80 | 80 |
| BR (2) | 20 | 20 | 20 |
| ZP200MP | 80 | | |
| S13 | | 80 | |
| S5 | | | 80 |
| TESPT (3) | 7.7 | 7.0 | 8.7 |
| Carbon black | 3.0 | 3.0 | 3.0 |
| Hydrocarbon resin (4) | 20 | 20 | 20 |
| stearic acid | 2 | 2 | 2 |
| 6-PPD (5) | 2.5 | 2.5 | 2.5 |
| ZnO | 1.2 | 1.2 | 1.2 |
| Sulfur | 1.0 | 1.0 | 1.0 |
| DPG (6) | 1.9 | 1.8 | 2.1 |
| CBS (7) | 2.3 | 2.3 | 2.3 |

(1) Oil extended solution SBR, Buna VSL4526-2HM from Lanxess with 45% of vinyl units; 26% of styrene units; Tg of −30° C., 37.5 phr of TDAE
(2) BR: Butyl Rubber Buna CB 25 from Lanxess
(3) TESPT: Bis[3-(triethoxysilyl)propyl] tetrasulfide, TESPT Luvomaxx, from Lehmann&Voss&Co
(4) Hydrocarbon resin SYLVATRAXX 4101 from Arizona Chemical
(5) 6PPD: N-(1,3-Dimethylbutyl)-N-phenyl-para-phenylenediamine, Santoflex 6-PPD from Flexsys
(6) DPG: Diphenylguanidine, Rhenogran DPG-80 from RheinChemie
(7) CBS: N-Cyclohexyl-2-benzothiazolesulfenamide, Rhenogran CBS-80 from RheinChemie

TABLE VI

| Composition/Silica | Z1165MP | S14 |
|---|---|---|
| SBR (1) | 80 | 80 |
| BR (2) | 20 | 20 |
| Z1165MP | 80 | |
| S14 | | 80 |
| TESPT (3) | 6.4 | 6.5 |
| Carbon black | 3.0 | 3.0 |
| Hydrocarbon resin (4) | 20 | 20 |
| stearic acid | 2 | 2 |
| 6-PPD (5) | 2.5 | 2.5 |
| ZnO | 1.2 | 1.2 |
| Sulfur | 1.0 | 1.0 |
| DPG (6) | 1.5 | 1.7 |
| CBS (7) | 2.3 | 2.3 |

(1) Oil extended solution SBR, Buna VSL4526-2HM from Lanxess with 45% of vinyl units; 26% of styrene units; Tg of −30° C., 37.5 phr of TDA
(2) BR: Butyl Rubber Buna CB 25 from Lanxess
(3) TESPT: Bis[3-(triethoxysilyl)propyl] tetrasulfide, TESPT Luvomaxx, from Lehmann&Voss&Co
(4) Hydrocarbon resin SYLVATRAXX 4101 from Arizona Chemical
(5) 6PPD: N-(1,3-Dimethylbutyl)-N-phenyl-para-phenylenediamine, Santoflex 6-PPD from Flexsys
(6) DPG: Diphenylguanidine, Rhenogran DPG-80 from RheinChemie
(7) CBS: N-Cyclohexyl-2-benzothiazolesulfenamide, Rhenogran CBS-80 from RheinChemie

### Process for the Preparation of the Rubber Compositions

Except the vulcanization conditions (see “Properties of the vulcanisates” here below), the rubber compositions of present example 16 were prepared as detailed in example 15.

### Properties of the Vulcanisates

The vulcanization conditions applied in present example 16 were:
vulcanization at 160° C. during 40 min for the compounds of table IV;
vulcanization at 150° C. during 50 min for the compounds of Tables V and VI.

Z index, tensile strength, elongation at break, Δ G′ and tan δ max were also determined as detailed in example 15.

Tear resistance was determined as follows.

To measure tear resistance, uniaxial tensile tests were carried out in accordance with the instructions of the standard ASTM D624 with type C test specimens at a rate of 500 mm/min on an Instron 5564 device. The tear resistance (=tear strength) was expressed in N/mm.

TABLE VII
results achieved with the compositions of table IV

| | Z1165MP | CS8 | CS9 | S10 | S11 | S12 |
|---|---|---|---|---|---|---|
| Z index | 87 | 81 | 69 | 87 | 94 | 90 |
| Tensile | 22.5 | 19.2 | 16.3 | 21.2 | 20.1 | 21.5 |
| strength | | | | | | |
| (Mpa) | | | | | | |
| Elongation at | 551 | 505 | 462 | 534 | 562 | 530 |
| break (%) | | | | | | |
| Δ G′ (Mpa) | 3.1 | 1.3 | 1.3 | 1.8 | 2.0 | 1.6 |
| tan δ max | 0.310 | 0.212 | 0.207 | 0.256 | 0.271 | 0.241 |

Silicas S10, S11 and S12 according to the invention exhibited an excellent dispersability (Z index). In comparison with commercial silica grade Zeosil©1165MP, the silicas according to the invention allowed to reduce significantly the energy dissipation (Δ G′, tan δ max) while keeping a good reinforcement: better macrodispersion (Z index), similar elongation at break and slightly lower tensile strength.

Silicas from the prior art, namely CS8 and CS9, provided a low energy dissipation but a poor dispersability (Z index) and a decrease in tensile strength and elongation at break.

All in all, the silicas according to the invention allowed for a better wear/energy dissipation compromise.

TABLE VIII
results achieved with the compositions of table V

| | ZP200MP | S13 | S5 |
|---|---|---|---|
| Z index | 74 | 91 | 91 |

Compared to commercial Zeosil® Premium 200MP silica, silicas S13 and S5 according to the invention exhibited a better dispersability.

TABLE IX
results achieved with the compositions of table VI

| | Z1165MP | S14 |
|---|---|---|
| Z index | 90 | 92 |
| Tear resistance (N/mm) | 58 | 57 |
| Tan δ max | 0.305 | 0.254 |

Compared to commercial Zeosil® 1165MP, silica S14 according to the invention allowed for a decrease in energy dissipation (tan δ max) while retaining a high dispersability (Z index) and a high tear resistance.

1. A precipitated silica comprising:
a CTAB surface area in a range from 40 to 525 m²/g;
primary particles having an average size measured by SAXS below 15 nm;
a rate of fines τf, that is to say a proportion (by weight) of particles of a size less than 1 m after deagglomeration by ultrasounds, which is of at least 91%; and
a particle size distribution measured by centrifugal sedimentation using a CPS, such that for a given value of the CTAB surface area, a parameter FWHM is defined by relation (I):
$$\vert FWHM \vert > - 0.16 \times \vert CTAB \vert + 130 \qquad ( I )$$

2. The precipitated silica according to claim 1, of which the CTAB surface area is from 120 to 275 m²/g.

3. (canceled)

4. The precipitated according to claim 1, of which the FWHM ranges from 100 to 250.

5. The precipitated silica according to claim 1, having a d₅₀ characterized by the following formula: |d₅₀|>−0.81×|CTAB|+263 (II).

6. The precipitated silica according to claim 5, of which the d₅₀ is between 110 nm and 240 nm.

7. The precipitated silica according to claim 1, having a d₈₄ characterised by the following formula: |d₈₄|<2.81×|FWHM|+35 (III).

8. The precipitated silica according to claim 7, of which the d₈₄ is comprised between 200 and 550 nm.

9. (canceled)

10. The precipitated silica according to claim 1, of which the rate of fines τf is of at least 92%.

11. The precipitated silica according to claim 10, of which the rate of fines is of at least 95%.

12. The precipitated silica according to claim 1, which is in a form of a powder or in a form of micropearls or in a form of granules.

13. (canceled)

14. (canceled)

15. A process for preparing a precipitated silica, said process comprising:
(i) providing a starting solution having a pH from 2.00 to 5.50,
(ii) simultaneously adding a silicate and an acid to said starting solution to obtain a reaction medium of which the pH is maintained in the range from 2.00 to 5.50,
(iii) stopping the addition of the acid and of the silicate and adding a base to the reaction medium to raise the pH of said reaction medium to a value from 7.00 to 10.00,
(iv) simultaneously adding to the reaction medium a silicate and an acid, such that the pH of the reaction medium is maintained in the range from 7.00 to 10.00,
(v) stopping the addition of the silicate while continuing the addition of the acid to the reaction medium to reach a pH of the reaction medium of less than 6.00 and obtaining a suspension of precipitated silica,
wherein step (i) comprises the following steps:
(ia) providing an aqueous medium eventually comprising an electrolyte as initial stock, (ib) simultaneously adding to this aqueous medium a silicate and an acid, such that the pH of the aqueous medium is maintained in the range from 7.00 to 10.00, wherein the amount of silicate added to the aqueous medium is between 1 and 10% of the total amount of silicate required for the reaction,
(ic) stopping the addition of silicate while continuing the addition of the acid to the aqueous medium obtained in step (ib) in order to provide the starting solution having a pH from 2.00 to 5.50.

16. The process according to claim 15, wherein a point of gel is reached during step (ii) and wherein a diluted acid is used until the gel point is reached and a concentrated acid is used after the point of gel is reached.

17. The process according to claim 15, wherein a point of gel is reached during step (ii) and wherein the amount of silicate added during step (ii) after the point of gel is reached is between 5% and 55% of the total amount of silicate added during step (ii).

18. The process according to claim 15, wherein the amount of silicate added to the reaction medium during step (iv) is at least 45% of the total amount of silicate required for the reaction.

19. The process according to claim 15, for preparing the precipitated silica comprising:
a CTAB surface area in a range from 40 to 525 m²/g;
primary particles having an average size measured by SAXS below 15 nm;
a rate of fines τf, that is to say a proportion (by weight) of particles of a size less than 1 μm after deagglomeration by ultrasounds, which is of at least 91%; and
a particle size distribution measured by centrifugal sedimentation using a CPS, such that for a given value of the CTAB surface area, a parameter FWHM is defined by relation (I):
$$\vert FWHM \vert > - 0.16 \times \vert CTAB \vert + 130 \qquad ( I )$$

20. (canceled)

21. (canceled)

22. A composition comprising the precipitated silica according to claim 1 and at least one polymer.

23. The composition according to claim 22, wherein the precipitated silica contains aluminium in an amount W_{Al} below 0.50 wt % and wherein the at least one polymer is one or more elastomer(s).

24. (canceled)

25. (canceled)

26. (canceled)

27. A part of a tire comprising the composition according to claim 23.

28. (canceled)

29. A tire comprising a tired tread comprising the composition according to claim 23.

30-32. (canceled)

33. A finished article comprising at least one part consisting of the composition according to claim 22, said finished article being selected from the group consisting of footwear soles, floor coverings, engineering components, seals, pipes, sheathings, cables, supports, separators and belts.

34. (canceled)

35. (canceled)
